(19) United States
(12) Patent Application Publication
(10) Pub. No.: US 2026/0189308 A1
(43) Pub. Date: Jul. 2, 2026

(54) Optical Source Monitoring in Optical Communication System

(71) Applicant: Ayar Labs, Inc., San Jose, CA (US)

(72) Inventor: Manan Raval, Oakland, CA (US)

(21) Appl. No.: 19/436,599

(22) Filed: Dec. 30, 2025

Related U.S. Application Data
(60) Provisional application No. 63/740,978, filed on Dec. 31, 2024.

(51) Int. Cl. H04B 10/572; G02B 6/293; H04J 14/02

(52) U.S. Cl. CPC H04B 10/572; H04J 14/0201; G02B 6/29382

(57) ABSTRACT

In an optical transmit macro of an electro-optical chip, a transmit bus optical waveguide is optically connected to an optical supply input and extends through a plurality of transmit slices, each of which includes a wavelength selective modulator optically coupled to the transmit bus optical waveguide. A mapping bus optical waveguide extends through the plurality of transmit slices. A scanning detector is disposed along the transmit bus optical waveguide at a location between the optical supply input and the plurality of transmit slices. The scanning detector diverts a mapping light having a mapping wavelength from the transmit bus optical waveguide to the mapping bus optical waveguide. A phase shifter imparts a phase modulation pattern onto the mapping light. The mapping light is then combined with a drop portion of light from each wavelength selective modulator to determine if the mapping wavelength matches a resonance wavelength of the wavelength selective modulator.

### CROSS-REFERENCE TO RELATED APPLICATIONS

This application claims priority under 35 U.S.C. 119(e) to U.S. Provisional Patent Application No. 63/740,978, filed on Dec. 31, 2024, the disclosure of which is incorporated herein by reference in its entirety for all purposes.

### BACKGROUND OF THE INVENTION

### 1. Field of the Invention

The present invention relates to optical data communication.

### 2. Description of the Related Art

Optical data communication systems operate by modulating laser light to encode digital data patterns within optical signals. In some embodiments, a ring modulator is used to modulate continuous wave laser light to generate the modulated laser light that conveys the encoding of digital data patterns. In some embodiments, the ring modulator is positioned within an evanescent optically coupling distance from a bus optical waveguide and operates to modulate light that is propagating through the bus optical waveguide. The ring modulator and associated optical waveguides are fabricated within an electro-optic chip and/or photonic integrated chip. The modulated laser light is transmitted through an optical data network from a sending node to a receiving node. The modulated laser light having arrived at the receiving node is de-modulated to obtain the original digital data patterns from the optical signals. The transmission of light through the optical data network includes transmission of light through optical fibers and transmission of light between optical fibers and photonic integrated circuits within electro-optic and/or photonic integrated chips. In some embodiments, implementation and operation of optical data communication systems is dependent upon having efficient and accurate resonance wavelength locking of the ring modulators. It is within this context that the present invention arises.

### SUMMARY OF THE INVENTION

In an example embodiment, an optical transmit macro of an electro-optical chip is disclosed. The optical transmit macro includes a transmit bus optical waveguide optically connected to an optical supply input. The optical transmit macro also includes a plurality of transmit slices. The transmit bus optical waveguide extends through the plurality of transmit slices. Each of the plurality of transmit slices includes a wavelength selective modulator optically coupled to the transmit bus optical waveguide. The wavelength selective modulator is configured to modulate a selected wavelength of light that is being conveyed through the transmit bus optical waveguide. The optical transmit macro also includes a mapping bus optical waveguide extending through the plurality of transmit slices. The optical transmit macro also includes a scanning detector disposed along the transmit bus optical waveguide at a location between the optical supply input and the plurality of transmit slices. The scanning detector is configured to provide controlled diversion of a portion of light having a particular wavelength from the transmit bus optical waveguide to the mapping bus optical waveguide. The portion of light diverted by the scanning detector is a mapping light. The particular wavelength of the mapping light is a mapping wavelength. The optical transmit macro also includes a phase shifter optically coupled to the mapping bus optical waveguide at a location between the scanning detector and the plurality of transmit slices. The phase shifter is configured to impart a phase modulation pattern onto the mapping light conveyed through the mapping bus optical waveguide. Each of the plurality of transmit slices is configured to combine a portion of the mapping light from within the mapping bus optical waveguide with a drop portion of light currently coupled into the wavelength selective modulator of said each of the plurality of transmit slices to determine whether or not the phase modulation pattern of the mapping light is imparted onto the drop portion of light, so as to indicate a match between the mapping wavelength and a resonance wavelength of the wavelength selective modulator of said each of the plurality of transmit slices.

In an example embodiment, a method is disclosed for mapping resonance wavelengths of wavelength selective modulators across an optical transmit macro of an electro-optical chip. The method includes conveying a plurality of wavelengths of continuous wave light through a transmit bus optical waveguide that extends through a plurality of transmit slices of an optical transmit macro of an electro-optical chip. Each of the plurality of transmit slices includes a wavelength selective modulator optically coupled to the transmit bus optical waveguide. The wavelength selective modulator is configured to modulate a selected one of the plurality of wavelengths of continuous wave light that is being conveyed through the transmit bus optical waveguide. The method also includes operating the wavelength selective modulator in each of the plurality of transmit slices to modulate said selected one of the plurality of wavelengths of continuous wave light that is being conveyed through the transmit bus optical waveguide. The method also includes operating a scanning detector to divert a portion of light having a particular wavelength from the transmit bus optical waveguide to a mapping bus optical waveguide. The portion of light diverted by the scanning detector is a mapping light. The particular wavelength of the mapping light is a mapping wavelength. The mapping bus optical waveguide extends from the scanning detector through the plurality of transmit slices. The method also includes operating a phase shifter to impart a phase modulation pattern onto the mapping light conveyed through the mapping bus optical waveguide at a location upstream from the plurality of transmit slices relative to a light propagation direction through the mapping bus optical waveguide. The method also includes combining a portion of the mapping light from the mapping bus optical waveguide with a drop portion of light currently optically coupled into the wavelength selective modulator in each of the plurality of transmit slices to determine whether or not the phase modulation pattern of the mapping light is imparted onto the drop portion of light. Imparting of the phase modulation pattern of the mapping light onto the drop portion of light is indicative of a match between the mapping wavelength of the mapping light and a resonance wavelength of the wavelength selective modulator from which the drop portion of light is obtained.

In an example embodiment, an optical transmit macro of an electro-optical chip is disclosed. The optical transmit macro includes a transmit bus optical waveguide optically connected to an optical supply input. The optical transmit macro also includes a plurality of transmit slices. The transmit bus optical waveguide extends through the plurality of transmit slices. Each of the plurality of transmit slices includes a wavelength selective modulator optically coupled to the transmit bus optical waveguide. The wavelength selective modulator is configured to modulate a selected wavelength of light that is being conveyed through the transmit bus optical waveguide. Each of the plurality of transmit slices includes a photodetector optically connected to receive a drop portion of light currently coupled into the wavelength selective modulator of said each of the plurality of transmit slices. The optical transmit macro also includes a scanning detector disposed along the transmit bus optical waveguide at a location between the optical supply input and the plurality of transmit slices. The scanning detector is configured to provide controlled diversion of a portion of light having a mapping wavelength from the transmit bus optical waveguide, which correspondingly causes a drop in optical power detected by one of the photodetectors within a given one of the plurality of transmit slices that receives the drop portion of light that has a wavelength equal to the mapping wavelength, which in turn indicates that the wavelength selective modulator of the given one of the plurality of transmit slices has a resonance wavelength equal to the mapping wavelength.

In an example embodiment, a method is disclosed for mapping resonance wavelengths of wavelength selective modulators across an optical transmit macro of an electro-optical chip. The method includes conveying a plurality of wavelengths of continuous wave light through a transmit bus optical waveguide that extends through a plurality of transmit slices of an optical transmit macro of an electro-optical chip. Each of the plurality of transmit slices includes a wavelength selective modulator and a photodetector. The wavelength selective modulator is optically coupled to the transmit bus optical waveguide. The wavelength selective modulator is configured to modulate a selected one of the plurality of wavelengths of continuous wave light that is conveyed through the transmit bus optical waveguide. The photodetector is optically connected to receive a drop portion of light from the wavelength selective modulator within a same one of the plurality of transmit slices. The method also includes operating the wavelength selective modulator in each of the plurality of transmit slices to modulate said selected one of the plurality of wavelengths of continuous wave light that is being conveyed through the transmit bus optical waveguide. The method also includes conveying the drop portion of light that is currently being modulated by the wavelength selective modulator in each of the plurality of transmit slices to the photodetector within said each of the plurality of transmit slices. The method also includes operating the photodetector within each of the plurality of transmit slices to generate a photocurrent corresponding to the drop portion of light that is currently being received by said photodetector. The method also includes operating a scanning detector to divert a portion of light having a mapping wavelength from the transmit bus optical waveguide to cause a drop in optical power detected by a given one of the photodetectors that receives the drop portion of light that has a wavelength equal to the mapping wavelength. The drop in optical power detected by the given one of the photodetectors indicates that the wavelength selective modulator that provided the drop portion of light to the given one of the photodetectors has a resonance wavelength equal to the mapping wavelength.

### BRIEF DESCRIPTION OF THE DRAWINGS

FIG. 1A shows an example implementation of a remote optical power supply for an optical data communication system, in accordance with some embodiments.

FIG. 1B shows a diagram indicating how each of the optical fibers of the M-port optical fiber array receives and conveys each of the multiple wavelengths (λ₁ to λ_{N}) of CW laser light from the remote optical power supply, in accordance with some embodiments.

FIG. 1C shows an example diagram of the electro-optical chip connected to the M-port optical fiber array that includes optical fibers, in accordance with some embodiments.

FIG. 1D shows an example embodiment of a transmit macro designed to modulate eight wavelengths (λ₁ to λ₈), in accordance with some embodiments.

FIG. 1E shows a diagram indicating how each of the wavelengths λ₁ to λ₈ of CW light arrives at the optical supply input and is conveyed into the single transmit bus optical waveguide with substantially equal optical intensity, in accordance with some embodiments.

FIG. 2A shows a transmit macro configured to provide for monitoring of relative changes in optical power and optical wavelength for each of N wavelengths (λ₁ to λ_{N}) of CW light injected into the transmit macro, by way of the optical supply input, in order to determine a modulator-to-wavelength mapping for the transmit macro, in accordance with some embodiments.

FIG. 2B shows an example implementation of the transmit macro of FIG. 2A, in accordance with some embodiments.

FIG. 3A shows the optical conveyance through the transmit bus optical waveguide at each of locations L1, L2, L3, L4, and L5, as referenced in FIG. 2A, in an example embodiment in which the transmit macro includes eight transmit slices, in accordance with some embodiments.

FIG. 3B shows the optical conveyance through the mapping bus optical waveguide at each of locations L6, L7, L8, and L9, as referenced in FIG. 2A, in the example embodiment in which the transmit macro includes eight transmit slices, in accordance with some embodiments.

FIG. 3C shows the photocurrents generated by the mapping photodetectors during the resonance wavelength mapping for the wavelength selective modulators for the example optical conveyances shown in FIGS. 3A and 3B, in accordance with some embodiments.

FIG. 3D shows the photocurrents generated by the mapping photodetectors during the resonance wavelength mapping for the wavelength selective modulators for the example optical conveyances shown in FIGS. 3A and 3B, in which the wavelength selective modulators have a non-sequential ordering across the transmit macro, in accordance with some embodiments.

FIG. 4A shows a variant of the transmit macro of FIG. 2A in which each transmit slice is modified to include a respective one of a plurality of ring locking photodetectors that are implemented separately from the corresponding mapping photodetectors, in accordance with some embodiments.

FIG. 4B shows an example implementation of the transmit macro of FIG. 4A, in accordance with some embodiments.

FIG. 4C shows the steady-state photocurrents generated by the ring locking photodetectors during the resonance wavelength mapping for the wavelength selective modulators for the example optical conveyances shown in FIGS. 3A and 3B, in accordance with some embodiments.

FIG. 5 shows a flowchart of a method for mapping resonance wavelengths of wavelength selective modulators across the optical transmit macro of the electro-optical chip, in accordance with some embodiments.

FIG. 6A shows a transmit macro configured to provide for monitoring of relative changes in optical power and optical wavelength for each of N wavelengths (λ₁ to λ_{N}) of CW light injected into the transmit macro, by way of the optical supply input, in order to determine a modulator-to-wavelength mapping for the transmit macro, in accordance with some embodiments.

FIG. 6B shows an example implementation of the transmit macro of FIG. 6A, in accordance with some embodiments.

FIG. 7A shows the optical conveyance into the transmit bus optical waveguide from the optical supply input, in an example embodiment in which the transmit macro of FIG. 6A includes eight transmit slices, in accordance with some embodiments.

FIG. 7B shows the photocurrent generation by the photodetector of the scanning detector, in the example embodiment in which the transmit macro of FIG. 6A includes eight transmit slices, in accordance with some embodiments.

FIG. 7C shows the photocurrents generated by the photodetectors during the resonance wavelength mapping for the wavelength selective modulators for the example optical conveyances shown in FIG. 7A and for the example photodetector photocurrent generation shown in FIG. 7B, in accordance with some embodiments.

FIG. 8 shows a flowchart of a method for mapping resonance wavelengths of wavelength selective modulators across the optical transmit macro of the electro-optical chip, in accordance with some embodiments.

### DETAILED DESCRIPTION

In the following description, numerous specific details are set forth in order to provide an understanding of the embodiments disclosed herein. It will be apparent, however, to one skilled in the art that the embodiments disclosed herein may be practiced without some or all of these specific details. In other instances, well known process operations have not been described in detail in order not to unnecessarily obscure the disclosed embodiments.

In some embodiments, a high-bandwidth, multi-wavelength WDM (wavelength division multiplexed) optical communication system is provided in which light from an array of N single-wavelength lasers is distributed to M transmit optical macros on an electro-optical chip, which can be a CMOS (complementary metal-oxide-semiconductor) chip, an SOI (silicon-on-insulator) chip, or another type of semiconductor chip. In these embodiments, each of the M transmit optical macros has N modulators, such that the system produces N×M data channels. A light distribution network, which may be implemented internal or external to the electro-optical chip, delivers a fraction of the light from each laser in the N laser array to a bus waveguide in all M transmit optical macros, such that each bus waveguide conveys some amount of optical power from each of the N wavelengths. Each of the M transmit optical macros includes a ring modulator that locks onto a particular wavelength, but the mapping of wavelengths to modulators is unknown. If information about the wavelength-to-modulator mapping is known, and if information about the optical power and wavelength drift of each wavelength over time is known, said information is usable to optimize the ring modulator wavelength locking algorithm.

Each of the transmit macros within the electro-optical chip includes a transmit bus waveguide that carries multiple wavelengths of CW light to feed a set of ring modulators (one ring modulator per wavelength) that transform the CW light into a corresponding set of modulated light signals that each conveys a different stream of digital data. When the system is initialized, each ring modulator is optically tuned such that its resonance wavelength is locked onto a particular wavelength. In some embodiments, an optical detection mechanism is connected to each ring modulator (e.g., a photodetector is optically connected to a drop port of the ring modulator) to assist in locking of the ring modulator onto the particular wavelength. However, the specific wavelength that a given ring modulator locks onto may be unknown. Also, over time, the power and wavelength of the optical source may drift or fluctuate. The resonance wavelength of the ring modulator may be tuned to compensate for this drift or fluctuation in the optical power and wavelength of the optical source in order to maintain optimal modulation conditions, but the impact of this compensation will be limited if the power and relative wavelength shift of the light being modulated by the ring modulator are unknown. To address these issues, it is necessary to have information on the power and wavelength drift of each wavelength of light generated by the optical source, and to know the actual wavelength onto which each ring modulator is locked. Therefore, a mechanism is needed to detect current information about both the power drift and wavelength drift of each individual wavelength of CW light provided by the optical source. Also, a mechanism is needed to obtain information about the wavelengths onto which the various ring modulators are currently locked. Using the above-mentioned information, the optimal resonance tuning can be applied to each ring modulator. Various embodiments are disclosed herein for obtaining the above-mentioned information in the electro-optical chip.

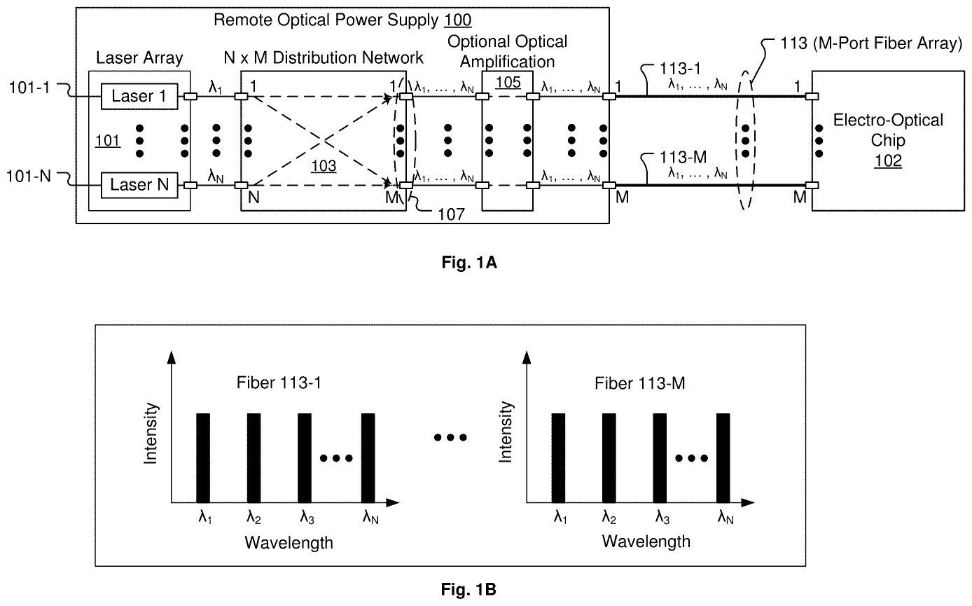

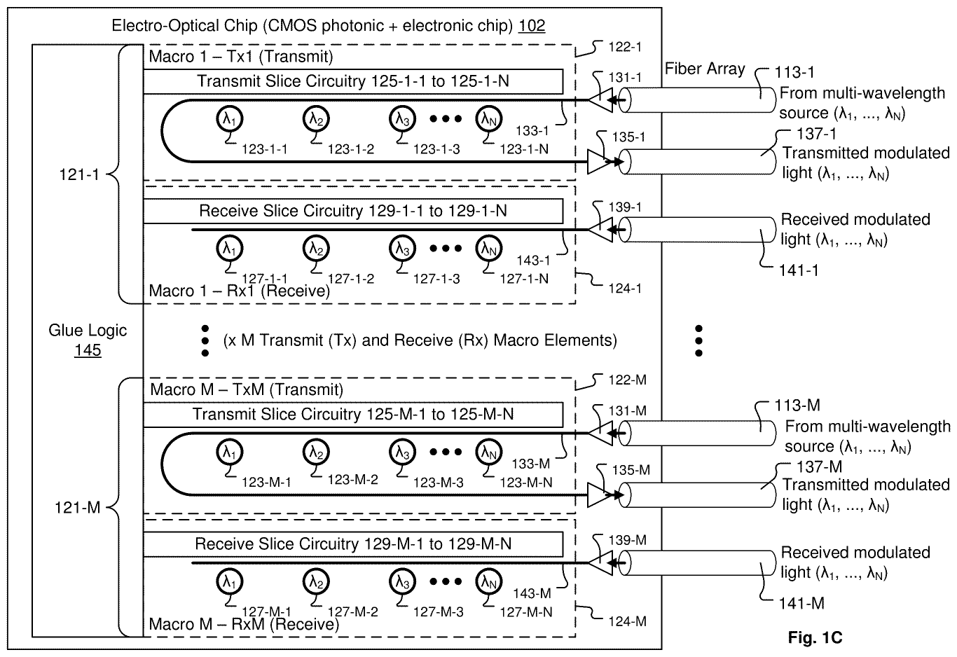

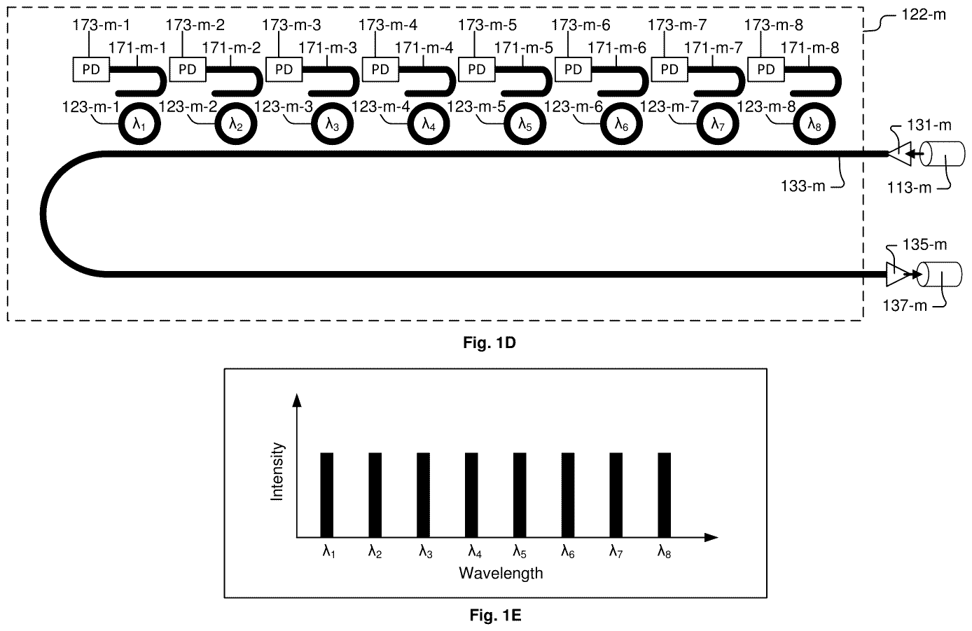

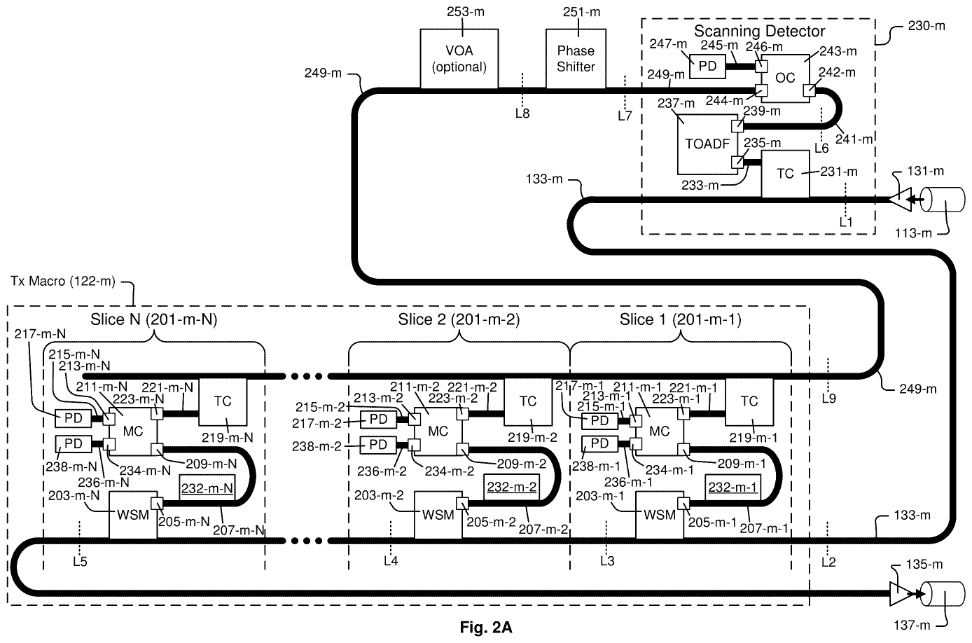

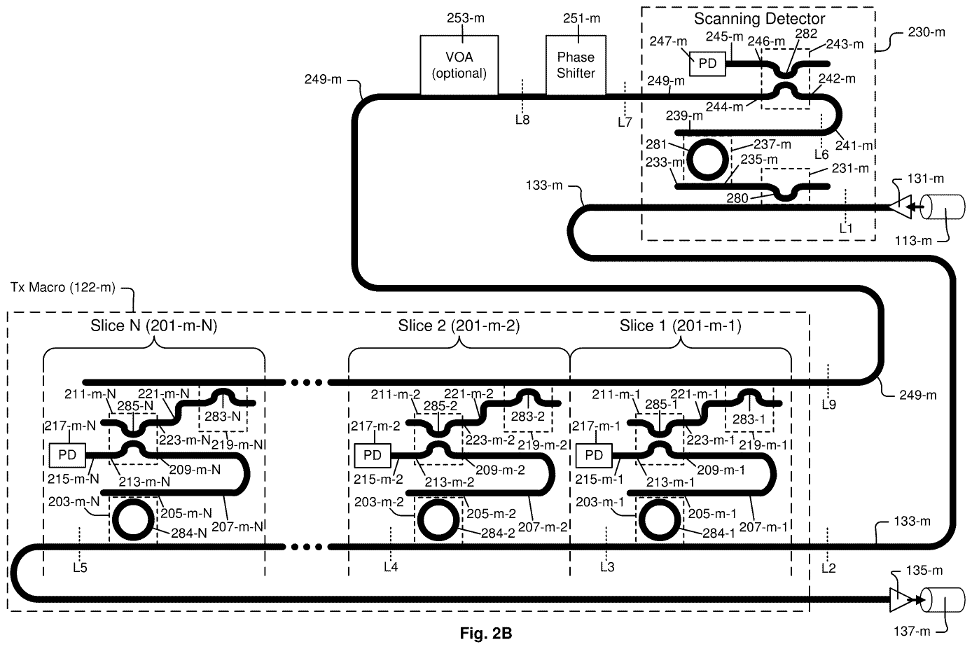

FIG. 1A shows an example implementation of a remote optical power supply 100 for an optical data communication system, in accordance with some embodiments. The remote optical power supply 100 includes a laser array 101, an N×M optical distribution network 103, and an optional optical amplification module 105. The laser array 101 includes a number (N) of lasers 101-1 to 101-N, where N is greater than one. Each laser 101-1 to 101-N is configured to generate and output continuous wave (CW) laser light of a different wavelength λ₁ to λ_{N}, respectively. The optical distribution network 103 routes the laser light at each of the N wavelengths, as generated by the multiple laser elements 101-1 through 101-N, to each of a number (M) of optical output ports 107 of the optical distribution network 103. In some embodiments, the optional optical amplification module 105 is not present and the multiple wavelengths (λ₁ to λ_{N}) of CW laser light that are directed to a given one of the (M) optical output ports 107 of the optical distribution network 103 are transmitted directly into a corresponding one of the optical fibers 113-1 to 113-M of an M-port optical fiber array 113. In some embodiments, the optional optical amplification module 105 is present and the multiple wavelengths (λ₁ to λ_{N}) of CW laser light that are directed to a given one of the (M) optical output ports 107 of the optical distribution network 103 are transmitted through the optical amplification module 105 for amplification in route to a corresponding one of the optical fibers 113-1 to 113-M of the M-port optical fiber array 113. In this manner, the remote optical power supply 100 operates to provide multiple wavelengths (λ₁ to λ_{N}) of CW laser light on each of the multiple optical fibers 113-1 to 113-M of the M-port optical fiber array 113. In some embodiments, each of the optical fibers 113-1 to 113-M of the M-port optical fiber array 113 is connected to route the multiple wavelengths (λ₁ to λ_{N}) of CW laser light that it receives from the remote optical power supply 100 to a corresponding optical supply port on the electro-optical chip 102.

FIG. 1B shows a diagram indicating how each of the optical fibers 113-1 to 113-M of the M-port optical fiber array 113 receives and conveys each of the multiple wavelengths (λ₁ to λ_{N}) of CW laser light from the remote optical power supply 100, in accordance with some embodiments. In some embodiments, each of the multiple wavelengths (λ₁ to λ_{N}) of CW laser light is output from the remote optical power supply 100 at a substantially equal intensity (power). However, in some embodiments, the optical power level of one or more of the multiple wavelengths (λ₁ to λ_{N}) of CW laser light as output from the remote optical power supply 100 is different than the optical power levels of others of the multiple wavelengths (λ₁ to λ_{N}) of CW laser light as output from the remote optical power supply 100.

FIG. 1C shows an example diagram of the electro-optical chip 102 connected to the M-port optical fiber array 113 that includes optical fibers 113-1 to 113-M, in accordance with some embodiments. The electro-optical chip 102 includes a number (M) of transmit/receive macros 121-1 to 121-M. Each transmit/receive macro 121-1 to 121-M includes a transmit macro 122-1 to 122-M having the microring resonators 123-x-1 to 123-x-M and corresponding transmit slice circuitry 125-x-1 to 125-x-N, where x identifies the particular one of the M transmit/receive macros 121-1 to 121-M. Each transmit/receive macro 121-1 to 121-M also includes a receive macro 124-1 to 124-M having the microring resonators 127-x-1 to 127-x-M and corresponding receive slice circuitry 129-x-1 to 129-x-N, where x identifies the particular one of the M transmit/receive macros 121-1 to 121-M. Each transmit macro 122-1 to 122-M includes an optical supply input 131-1 to 131-M, respectively, that is connected to a corresponding one of the optical fibers 113-1 to 113-M, respectively, to receive the multi-wavelength (λ₁ to λ_{N}) CW laser light from the remote optical power supply 100. In some embodiments, the number (M) of optical fibers 113-1 to 113-M required from the remote optical power supply 100 equals the number of transmit/receive macros 121-1 to 121-M of the electro-optical chip 102.

The optical supply inputs 131-1 to 131-M are connected to optical waveguides 133-1 to 133-M, respectively. Each of the optical waveguides 133-1 to 133-M extends past the number (N) of microring resonators 123-x-1 to 123-x-N, where x identifies the particular one of the M transmit/receive macros 121-1 to 121-M, so as to enable evanescent coupling of light between the optical waveguides 133-1 to 133-M and the corresponding set of microring resonators 123-x-1 to 123-x-N. Each of the microring resonators 123-x-1 to 123-x-N is operated as an optical ring modulator tuned to a corresponding one of the N wavelengths (λ₁ to λ_{N}) of the incoming CW laser light. Each of the microring resonators 123-x-1 to 123-x-N is controlled by the corresponding transmit slice circuitry 125-x-1 to 125-x-N to function as an optical ring modulator to modulate the incoming CW laser light of a particular wavelength (λ_{y}, where y is in the set of 1 to N) on the corresponding optical waveguide 133-1 to 133-M in accordance with electrical signals that represent digital data, so as to generate modulated light of the corresponding wavelength (λ_{y}) that has a modulation pattern that conveys the digital data represented by the electrical signals. After extending past each of the microring resonators 123-x-1 to 123-x-N, each of the optical waveguides 133-1 to 133-M extends to a respective optical signal output 135-1 to 135-M of the transmit macro 122-1 to 122-M. The modulated light is transmitted from the optical signal outputs 135-1 to 135-M into respective optical fibers 137-1 to 137-M that carry the modulated light to a destination somewhere within the optical data communication system.

Each receive macro 124-1 to 124-M of the transmit/receive macros 121-1 to 121-M includes an optical signal input 139-1 to 139-M, respectively, that is connected to a corresponding one of optical fibers 141-1 to 141-M, respectively, to receive modulated light of various wavelengths from other devices within the optical data communication system. The optical signal inputs 139-1 to 139-M are connected to optical waveguides 143-1 to 143-M, respectively. Each of the optical waveguides 143-1 to 143-M extends past the number (N) of microring resonators 127-x-1 to 127-x-N, where x identifies the particular one of the M transmit/receive macros 121-1 to 121-M, so as to enable evanescent coupling of light between the optical waveguides 143-1 to 143-M and the corresponding set of microring resonators 127-x-1 to 127-x-N. In some embodiments, each of the microring resonators 127-x-1 to 127-x-N is operated as an optical ring detector (photodetector) tuned to a corresponding one of the N wavelengths (λ₁ to λ_{N}) of the incoming modulated light. In some embodiments, each of the microring resonators 127-x-1 to 127-x-N is controlled by the corresponding receive slice circuitry 129-x-1 to 129-x-N to function as an optical ring detector (photodetector) to detect the incoming modulated light of a particular wavelength (λ_{y}, where y is in the set of 1 to N) on the corresponding optical waveguide 143-1 to 143-M. The microring resonators 127-x-1 to 127-x-N in conjunction with the corresponding receive slice circuitry 129-x-1 to 129-x-N functions to convert the incoming modulated light signals into corresponding electrical signals in accordance with the modulation pattern of the incoming light. The resulting electrical signals are processed by receive slice circuitry 129-x-1 to 129-x-N to recreate the digital data upon which the incoming modulated light was modulated.

The M transmit/receive macros 121-1 to 121-M are located between a photonic interface of the electro-optical chip 102 and an electrical interface of the electro-optical chip 102. The electrical interface of the electro-optical chip 102 is connected to the M transmit/receive macros 121-1 to 121-M by glue logic 145. In some embodiments, the glue logic 145 is adaptable to the logic of an integrated circuit chip to which the electro-optical chip 102 connects. The glue logic 145 also routes data between the electrical interface of the electro-optical chip 102 and the M transmit/receive macros 121-1 to 121-M. In some embodiments, the glue logic 145 enables dynamic mapping of electrical lanes/channels to optical lanes/channels. The glue logic 145 enables flexible (dynamic or static) mapping of the electrical interface of the electro-optical chip 102 to the M transmit/receive macros 121-1 to 121-M and associated optical wavelengths. In some embodiments, the glue logic 145 includes cross-bar switches and other circuitry as needed to provide dynamic routing of electrical signals between the M transmit/receive macros 121-1 to 121-M and the electrical interface of the electro-optical chip 102. In some embodiments, the glue logic 145 also provides for retiming, rebuffering, and flit reorganization functions at the phy-level. Also, in some embodiments, the glue logic 145 implements various error correction and data-level link protocols to offload some processing from the integrated circuit chip to which the electro-optical chip 102 connects.

FIG. 1D shows an example embodiment of a transmit macro 122-m, where m is any of 1 to M, designed to modulate eight wavelengths (λ₁ to λ₈), in accordance with some embodiments. FIG. 1D shows an example of how the multiple wavelengths (λ₁ to λ₈) of CW light received through the optical supply input 131-m are multiplexed onto the single transmit bus optical waveguide 133-m in each transmit macro 122-m, such that each of the multiple wavelengths (λ₁ to λ₈) of CW light is delivered to each of the microring resonators 123-m-1 to 123-m-8 within the transmit macro 122-m. FIG. 1E shows a diagram indicating how each of the wavelengths λ₁ to λ₈ of CW light arrives at the optical supply input 131-m and is conveyed into the single transmit bus optical waveguide 133-m with substantially equal optical intensity, in accordance with some embodiments. In some embodiments, the transmit macro 122-m includes photodetectors 173-m-1 to 173-m-8 optically connected to the microring resonators 123-m-1 to 123-m-8, respectively, by way of optical waveguides 171-m-1 to 171-m-8, respectively. Each of the optical waveguides 171-m-1 to 171-m-8 is configured and positioned to optically tap a portion of light from the corresponding one of the microring resonators 123-m-1 to 123-m-8. Each of the photodetectors 173-m-1 to 173-m-8 is configured to detect the light that is tapped by the corresponding optical waveguide 171-m-1 to 171-m-8 from the corresponding one of the microring resonators 123-m-1 to 123-m-8. Each of the photodetectors 173-m-1 to 173-m-8 generates an electrical photocurrent proportional to the optical power deposited therein. In some embodiments, each of the photodetectors 173-m-1 to 173-m-8 is tunable to detect optical power of a particular optical wavelength. For example, in some embodiments, the photodetectors 173-m-1 to 173-m-8 are respectively tuned to detect light having the wavelengths λ₁ to λ₈, respectively.

FIG. 2A shows a transmit macro 122-m configured to provide for monitoring of relative changes in optical power and optical wavelength for each of N wavelengths (λ₁ to λ_{N}) of CW light injected into the transmit macro 122-m, by way of the optical supply input 131-m, in order to determine a modulator-to-wavelength mapping for the transmit macro 122-m, in accordance with some embodiments. It should be understood that the transmit macro 122-m of FIG. 2A, where m is any of 1 to M, can be implemented as any one of the transmit macros 122-1 to 122-M in the electro-optical chip 102 described with regard to FIG. 1C. A scanning detector 230-m, for the macro m, is disposed between the optical supply input 131-m and the transmit macro 122-m. The scanning detector 230-m includes an optical tap coupler (TC) 231-m optically coupled to the transmit bus optical waveguide 133-m. The optical tap coupler (TC) 231-m is configured to function as an optical power tap that diverts a portion of optical power in the transmit bus optical waveguide 133-m into an optical waveguide 233-m that is optically connected to an optical input port 235-m of a tunable optical add/drop filter (TOADF) 237-m. In some embodiments, the optical tap coupler 231-m is broadband such that a portion of each wavelength (λ₁ to λ_{N}) of CW light is diverted from the transmit bus optical waveguide 133-m into the tunable optical add/drop filter 237-m. The tunable optical add/drop filter 237-m is configured to have a tunable resonance wavelength. The tunable optical add/drop filter 237-m is configured to convey light received through the optical input port 235-m that has a wavelength equal to the current setting of the tunable resonance wavelength through an optical output port 239-m of the tunable optical add/drop filter 237-m. The current setting of the tunable resonance wavelength of the tunable optical add/drop filter 237-m is referred to as the mapping wavelength. The light that has the mapping wavelength that is conveyed through the optical output port 239-m of the tunable optical add/drop filter 237-m is referred to as the mapping light.

In various embodiments, the tunable optical add/drop filter 237-m is implemented in various ways. For example, in some embodiments, the tunable optical add/drop filter 237-m is implemented as one or more of ring resonators, photonic crystal resonators, and Bragg gratings, among others. In some embodiments, the tunable optical add/drop filter 237-m includes multiple resonators to achieve the desired transfer function. For example, in some embodiments, the tunable optical add/drop filter 237-m includes multiple resonators placed in series along a common bus waveguide, coupled together to create a higher order filter, or implemented in a Vernier configuration to increase the effective free spectral range. In some embodiments, the tunable optical add/drop filter 237-m implements an electrical tuning mechanism for changing the resonance wavelength of the tunable optical add/drop filter 237-m. For example, in some embodiments, the tunable optical add/drop filter 237-m implements a thermo-optic tuning mechanism in which electrical current is driven through a nearby conductive structure to heat the tunable optical add/drop filter 237-m and correspondingly shift the resonance wavelength of the tunable optical add/drop filter 237-m, thereby enabling control of the mapping wavelength.

The scanning detector 230-m includes an optical waveguide 241-m that is optically connected to the optical output port 239-m (drop port 239-m) of the tunable optical add/drop filter 237-m. The scanning detector 230-m includes an optical coupler (OC) 243-m to which the optical waveguide 241-m is optically connected. The optical waveguide 241-m conveys the mapping light to an optical input port 242-m of the optical coupler 243-m. The optical coupler 243-m is configured to convey the mapping light through a first optical output port 244-m and into a mapping bus optical waveguide 249-m. The optical coupler 243-m is also configured to convey a portion of the mapping light through a second optical output port 246-m and into a photodetector (PD) 247-m of the scanning detector 230-m by way of an optical waveguide 245-m. In various embodiments, the optical coupler 243-m is configured as an optical device that receives input optical power through a optical input port and that conveys a portion of the received optical power to each of at least two optical output ports. In some embodiments, the optical coupler 243-m is one or more of a directional optical coupler, an adiabatic optical coupler, and a multimode interferometer, among others.

As the tunable optical add/drop filter 237-m is tuned, a photocurrent is generated in the photodetector 247-m as the resonance wavelength of the tunable optical add/drop filter 237-m scans across any of the wavelengths (λ₁ to λ_{N}) of CW light that are conveyed into the transmit bus optical waveguide 133-m from the optical supply input 131-m. The photocurrent in the photodetector 247-m corresponds to the optical power of a given one of the wavelengths (λ₁ to λ_{N}). The electrical power that is used to tune the tunable optical add/drop filter 237-m at a given time corresponds to the resonance wavelength of the tunable optical add/drop filter 237-m at the given time. Tracking the photocurrent of the photodetector 247-m as a function of the electrical power used to tune the tunable optical add/drop filter 237-m provides information about the relative wavelengths (λ₁ to λ_{N}) at which optical power exists in the transmit bus optical waveguide 133-m. Therefore, for embodiments that use electrical heater power to adjust the resonance wavelength of the tunable optical add/drop filter 237-m, tracking of the photocurrent of the photodetector 247-m as a function of the electrical power used to tune the tunable optical add/drop filter 237-m effectively provides a spectrum of photodetector 247-m photocurrent versus heater power, which is then calibrated to extract optical power in the transmit bus optical waveguide 133-m as a function of wavelength for each of the wavelengths (λ₁ to λ_{N}). In these embodiments, by continuously scanning of the resonance wavelength of the tunable optical add/drop filter 237-m across all of the wavelengths (λ₁ to λ_{N}) of CW light in the transmit bus optical waveguide 133-m, time-dependent information is obtained about relative changes/drift in both the optical power and wavelength of all the optical source wavelengths (λ₁ to λ_{N}) of CW light conveyed into the in the transmit bus optical waveguide 133-m.

The transmit macro 122-m includes a number N of transmit slices 201-m-1 to 201-m-N. The transmit bus optical waveguide 133-m extends through each of the transmit slices 201-m-1 to 201-m-N, and then to the optical signal output 135-m of the transmit macro 122-m. Each of the transmit slices 201-m-1 to 201-m-N includes a respective wavelength selective modulator (WSM) 203-m-1 to 203-m-N that is optically coupled to the transmit bus optical waveguide 133-m. Each of the wavelength selective modulators 203-m-1 to 203-m-N is configured to modulate CW light of a particular wavelength propagating through the transmit bus optical waveguide 133-m. In some embodiments, each of the wavelength selective modulators 203-m-1 to 203-m-N is tunable to operate at the particular wavelength, such as by thermal resonance wavelength tuning. In various embodiments, each of the wavelength selective modulators 203-m-1 to 203-m-N includes one or more of a microring modulator, Mach-Zehnder modulator (MZM), ring-assisted Mach-Zehnder interferometric (RAMZI) modulator, ring-assisted Mach-Zehnder modulator (RAMZM), electro-absorption modulator (EAM), or other type of integrated optical modulator known in the optical data communication industry.

Each particular one of the wavelength selective modulators 203-m-1 to 203-m-N includes an optical drop port 205-m-1 to 205-m-N, respectively, through which is conveyed a portion of the light that is currently coupled into the particular one of the wavelength selective modulators 203-m-1 to 203-m-N. Each transmit slice 201-m-1 to 201-m-N includes a mapping coupler 211-m-1 to 211-m-N, respectively. For a given transmit slice 201-m-s, where(s) is any of 1 to N, the optical drop port 205-m-s of the corresponding wavelength selective modulator 203-m-s is optically connected to a first optical input port 209-m-s of the mapping coupler 211-m-s through an optical waveguide 207-m-s. In this manner, the portion of the light that is currently conveyed through the optical drop port 205-m-s of the wavelength selective modulator 203-m-s is currently conveyed into the mapping coupler 211-m-s.

Each mapping coupler 211-m-1 to 211-m-N also has a second optical input port 223-m-1 to 223-m-N, respectively, that is optically connected to receive the mapping light from the mapping bus optical waveguide 249-m. More specifically, each of the transmit slices 201-m-1 to 201-m-N includes a respective one of optical tap couplers 219-m-1 to 219-m-N. The optical tap coupler (TC) 219-m-s, where(s) is any of 1 to N, is configured to function as an optical power tap that diverts a portion of optical power in the mapping bus optical waveguide 249-m into an optical waveguide 221-m-s that is optically connected to the second optical input port 223-m-s of the corresponding mapping coupler 211-m-s. In some embodiments, the optical tap coupler 219-m-s is broadband such that a portion of light of any wavelength (λ₁ to λ_{N}) is diverted from the mapping bus optical waveguide 249-m into the corresponding mapping coupler 211-m-s, when said light is present in the mapping bus optical waveguide 249-m. Also, it should be understood that the optical tap couplers 219-m-1 to 219-m-N are collectively configured so that each transmit slice 201-m-1 to 201-m-N is able to couple a portion of the mapping light from the mapping bus optical waveguide 249-m into the corresponding mapping coupler 211-m-1 to 211-m-N.

In some embodiments, a variable optical attenuator (VOA) 253-m, where the index (m) denotes the number of the transmit macro 122-m, is optically connected to the mapping bus optical waveguide 249-m at a location between the scanning detector 230-m and the corresponding transmit macro 122-m. The VOA 253-m is configured to provide for active control of an amount of optical power that is conveyed through the mapping bus optical waveguide 249-m to the transmit macro 122-m at a given time. In this manner, the VOA 253-m is operated to control an amount of optical power that reaches the mapping couplers 211-m-1 to 211-m-N by way of the mapping bus optical waveguide 249-m, optical tap couplers 219-m-1 to 219-m-N, and optical waveguides 221-m-1 to 221-m-N. In some embodiments, the VOA 253-m is positioned immediately downstream of the phase shifter 251-m relative to the direction of light propagation through the mapping bus optical waveguide 249-m. In some embodiments, the VOA 253-m is implemented as an electro-optical amplitude modulation device, such as an electro-absorption modulator or a Mach-Zehnder interferometer, among others. In some embodiments in which the modulator-to-wavelength mapping is done only once, it is beneficial to minimize optical power traveling from the scanning detector 230-m to the transmit macro 122-m to ensure that the optical power does not interfere with the resonance wavelength locking algorithm of the wavelength selective modulators 203-m-1 to 203-m-N. It should be understood that implementation of the VOA 253-m is optional. Therefore, in some embodiments, where active control of the optical power within the mapping bus optical waveguide 249-m is not necessary, the VOA 253-m is not present.

Each of the mapping couplers 211-m-1 to 211-m-N has an optical output port 213-m-1 to 213-m-N, respectively. Each of the transmit slices 201-m-1 to 201-m-N includes a mapping photodetector (PD) 217-m-1 to 217-m-N that is optically connected to the optical output port 213-m-1 to 213-m-N, respectively, of the corresponding mapping coupler 211-m-1 to 211-m-N, respectively, by way of an optical waveguide 215-m-1 to 215-m-N, respectively. The light that is received through the first optical input port 209-m-s of the mapping coupler 211-m-s at a given time is referred to as the current drop light and corresponds to the light that is currently conveyed through the optical drop port 205-m-s of the wavelength selective modulator 203-m-s. The light that is received through the second optical input port 223-m-s of the mapping coupler 211-m-s at the given time is the current mapping light conveyed through the mapping bus optical waveguide 249-m at the given time. The current drop light and the current mapping light will only interfere with each other within the mapping coupler 211-m-s when the current drop light and the current mapping light are coherent with each other. This means that the current drop light and the current mapping light will only interfere with each other within the mapping coupler 211-m-s when the current drop light and the current mapping light have the same wavelength. The optical output of the mapping coupler 211-m-s is conveyed into the corresponding mapping photodetector 217-m-s, which is operated to determine whether or not the current drop light and the current mapping light have interfered with each other within the mapping coupler 211-m-s and corresponding have the same wavelength. More specifically, the photocurrents generated by each of the mapping photodetector 217-m-1 to 217-m-N are monitored as a function of time to determine when the wavelength of the current drop light of a given one of the transmit slices 201-m-1 to 201-m-N matches the wavelength of the current mapping light. Therefore, as the wavelength of the mapping light is changed over time, by way of the tunable optical add/drop filter 237-m within the scanning detector 230-m, the relative ordering of the resonance wavelengths of the wavelength selective modulators 203-m-1 to 203-m-N within the transmit slices 201-m-1 to 201-m-N, respectively, is determined by monitoring the photocurrents generated by the mapping photodetector 217-m-1 to 217-m-N.

As the resonance wavelength of the tunable optical add/drop filter 237-m is changed over time, optical power from only a particular one of the wavelengths (λ₁ to λ_{N}) of CW light is diverted from the transmit bus optical waveguide 133-m into the mapping bus optical waveguide 249-m as the mapped light at a given time when the resonance wavelength of the tunable optical add/drop filter 237-m matches the particular one of the wavelengths (λ₁ to λ_{N}). Correspondingly, at the given time, optical interference occurs in one of the mapping couplers 211-m-1 to 211-m-N that is optically connected to the particular one of wavelength selective modulators 203-m-1 to 203-m-N that is locked onto a resonance wavelength that matches the wavelength of the mapped light within the mapping bus optical waveguide 249-m at the given time. Observance of the optical interference within the particular one of the mapping couplers 211-m-1 to 211-m-N, by way of the photocurrent generated by the corresponding one of the mapping photodetectors 217-m-1 to 217-m-N, provides for determination of which of the transmit slices 201-m-1 to 201-m-N is locked onto the same wavelength as the current resonance wavelength of the tunable optical add/drop filter 237-m within the scanning detector 230-m. In this manner, by scanning the resonance wavelength of the tunable optical add/drop filter 237-m within the scanning detector 230-m over a wavelength range that bounds the operational wavelengths (λ₁ to λ_{N}) of the transmit slices 201-m-1 to 201-m-N, a determination is made as to which of the transmit slices 201-m-1 to 201-m-N is operating at a given one of the operational wavelengths (λ₁ to λ_{N}) at a given time. In some embodiments, only one of the wavelength selective modulators 203-m-1 to 203-m-N within a given transmit macro 122-m is locked onto a particular one of the operational wavelengths (λ₁ to λ_{N}) at a given time.

In some embodiments, a phase shifter 251-m is optically coupled to the mapping bus optical waveguide 249-m at a location between the scanning detector 230-m and the transmit macro 122-m. The phase shifter 251-m is configured to impart a phase modulation pattern onto the mapping light conveyed through the mapping bus optical waveguide 249-m. After the mapping light having the phase modulation pattern imparted thereon propagates through a given mapping coupler 211-m-s, where s is any of 1 to N, the phase modulation pattern imparted onto the mapping light appears as an amplitude modulation of the optical power at the corresponding optical output port 213-m-s of the mapping coupler 211-m-s. Therefore, the phase modulation pattern imparted onto the mapping light appears in the photocurrent generated by the corresponding mapping photodetector 217-m-s that is optically connected to the optical output port 213-m-s of the mapping coupler 211-m-s.

Since the mapping light that is conveyed through the mapping bus optical waveguide 249-m at a particular time has only a single wavelength (one of λ₁ to λ_{N}), the phase modulation pattern that is imparted by the phase shifter 251-m onto the mapping light will appear in the photocurrent of only one of the mapping photodetectors 217-m-1 to 217-m-N at the particular time, and thereby indicate which of the transmit slices 201-m-1 to 201-m-N has its wavelength selective modulator 203-m-1 to 203-m-N, respectively, locked onto the same wavelength as the current mapping wavelength at the particular time. As the tunable optical add/drop filter 237-m of the scanning detector 230-m scans across all the wavelengths (λ₁ to λ_{N}), a map of which wavelength each wavelength selective modulator 203-m-1 to 203-m-N is locked onto is generated based on the monitored photocurrents of the corresponding mapping photodetectors 217-m-1 to 217-m-N.

In some embodiments, as an option, for the given transmit slice 201-m-s, where (s) is any of 1 to N, a passive optical attenuator 232-m-s is optically connected along the optical conveyance pathway through the optical waveguide 207-m-s between the optical drop port 205-m-s of the corresponding wavelength selective modulator 203-m-s and the first optical input port 209-m-s of the mapping coupler 211-m-s. In some embodiments, the passive optical attenuator 232-m-s is configured to provide for balancing of the optical power of the drop light with the optical power of the mapping light in order to have a better extinction ratio on the photocurrent generated by the mapping photodetector 217-m-s. In some embodiments, the passive optical attenuator 232-m-s is implemented as an optical coupler, by way of example. In some embodiments, the passive optical attenuator 232-m-s is implemented as an extra length of optical waveguide, by way of example. In some embodiments, the passive optical attenuator 232-m-s is implemented as a combination of an optical coupler and an extra length of optical waveguide, by way of example.

Also, in some embodiments, as an option, for the given transmit slice 201-m-s, where (s) is any of 1 to N, a supplemental photodetector 238-m-s is optically connected through an optical waveguide 236-m-s to a second optical output port 234-m-s of the mapping coupler 211-m-s. For example, in some embodiments, the mapping coupler 211-m-s is configured as a two-input by two-output optical coupler that conveys a portion of the optical output through each of the first optical output port 213-m-s and the second optical output port 234-m-s. In these embodiments, the supplemental photodetector 238-m-s serves as a balanced photodetector relative to the mapping photodetector 217-m-s.

FIG. 2B shows an example implementation of the transmit macro 122-m of FIG. 2A, in accordance with some embodiments. In the example of FIG. 2B, the optical tap coupler 231-m is implemented as an evanescent tap 280 configured to direct a portion of the optical power within the transmit bus optical waveguide 133-m TX to the tunable optical add/drop filter 237-m. Also, in the example of FIG. 2B, the tunable optical add/drop filter 237-m is implemented as microring resonator 281 that is resonance wavelength tunable, such as through control of a temperature of the microring resonator 281. Also, in the example of FIG. 2B, the optical coupler 243-m is implemented as a 2×2 optical coupler 282 having a first optical input port that serves as the optical input port 242-m of the optical coupler 243-m. A second optical input port of the 2×2 optical coupler 282 is optically disconnected. A first optical output port of the 2×2 optical coupler 282 serves as the first optical output port 244-m that is optically connected to the mapping bus optical waveguide 249-m. A second optical output port of the 2×2 optical coupler 282 serves as the second optical output port 246-m that is optically connected to the photodetector 247-m by way of the optical waveguide 245-m. In this manner, the 2×2 optical coupler 282 is configured to convey a first portion of the optical power received through the optical input port 242-m through the first optical output port 244-m, and convey a second portion of the optical power received through the optical input port 242-m through the second optical output port 246-m. Therefore, the wavelength of the light that is conveyed into the photodetector 247-m at a given time is identical to the wavelength of the mapping light that is conveyed into the mapping bus optical waveguide 249-m at the given time.

Also, in the example of FIG. 2B, the optical tap couplers 219-m-1 to 219-m-N are implemented as evanescent taps 283-1 to 283-N, respectively, each of which is configured to direct a portion of the optical power within the mapping bus optical waveguide 249-m to the corresponding one of the mapping couplers 211-m-1 to 211-m-N. Also, in the example of FIG. 2B, the wavelength selective modulators 203-m-1 to 203-m-N are implemented as microring modulators 284-m-1 to 284-m-N, respectively, each of which is evanescently optically coupled to the transmit bus optical waveguide 133-m. In some embodiments, each of the microring modulators 284-m-1 to 284-m-N is resonance wavelength tunable, such as through control of respective temperatures of the microring modulators 284-m-1 to 284-m-N.

Also, in the example of FIG. 2B, the mapping couplers 211-m-1 to 211-m-N are implemented as 2×2 optical couplers 285-1 to 285-N, respectively. The 2×2 optical coupler 285-m-s has a first optical input port that serves as the first optical input port 209-m-s of the mapping coupler 211-m-s, where s is any one of 1 to N. The 2×2 optical coupler 285-m-s also has a second optical input port that serves as the second optical input port 223-m-s of the mapping coupler 211-m-s. The 2×2 optical coupler 285-m-s has a first optical output port that serves as the optical output port 213-m-s of the mapping coupler 211-m-s that is optically connected to the mapping photodetector 217-m-s by way of the optical waveguide 215-m-s. The 2×2 optical coupler 285-m-s has a second optical output port that is optically disconnected. In this manner, the 2×2 optical coupler 285-m-s is configured to combine the mapping light received from the mapping bus optical waveguide 249-m with the drop light from the corresponding microring modulator 284-m-s and convey the combination of the mapping light and the drop light to the mapping photodetector 217-m-s. In some embodiments, the photocurrent generated by the mapping photodetector 217-m-s is used for both resonance wavelength locking of the corresponding microring modulator 284-m-s and for resonance wavelength mapping of the microring modulators 284-m-1 to 284-m-N across the transmit slices 201-m-1 to 201-m-N of the transmit macro 122-m.

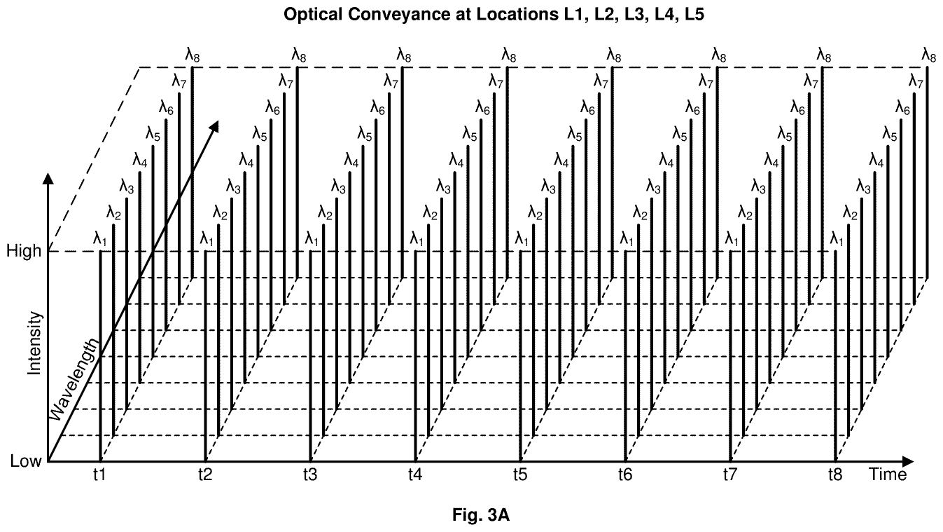

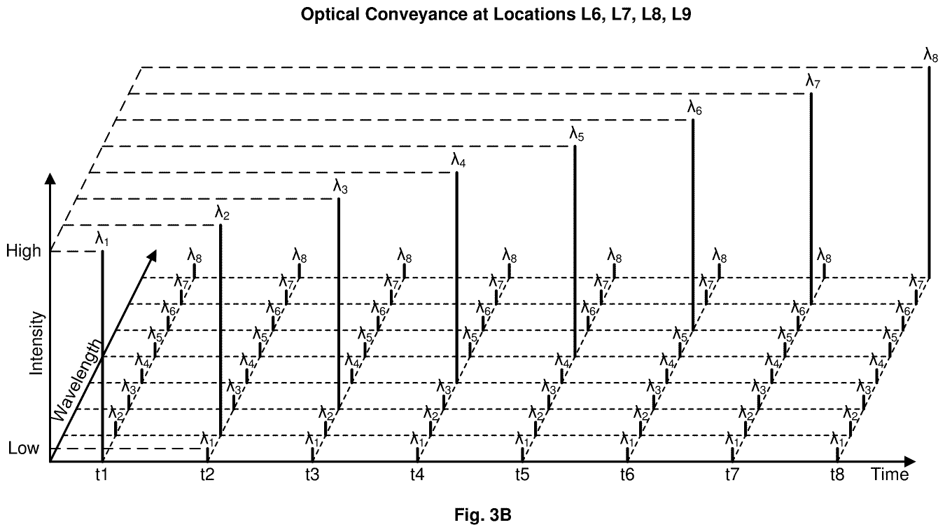

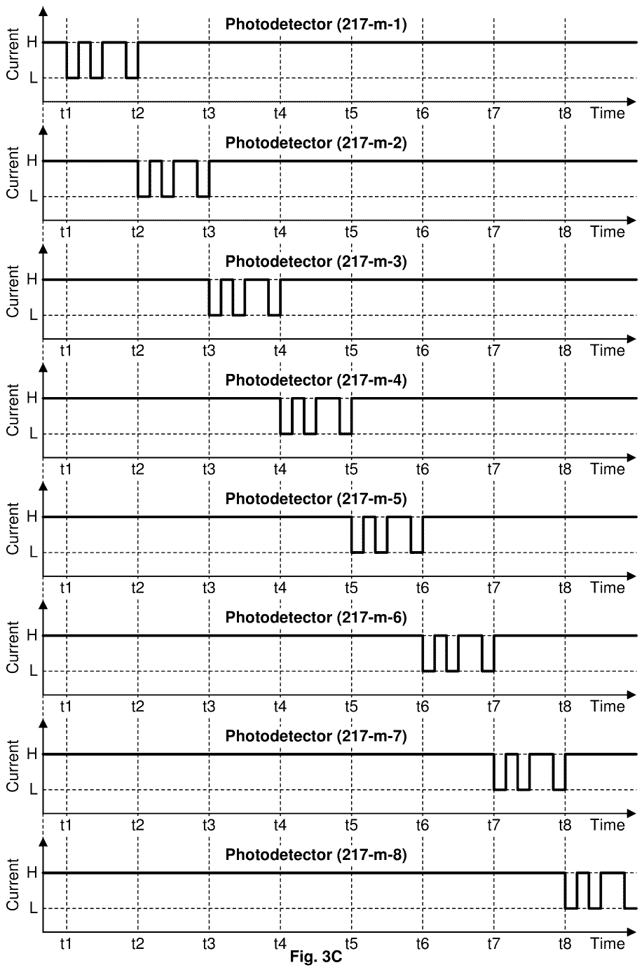

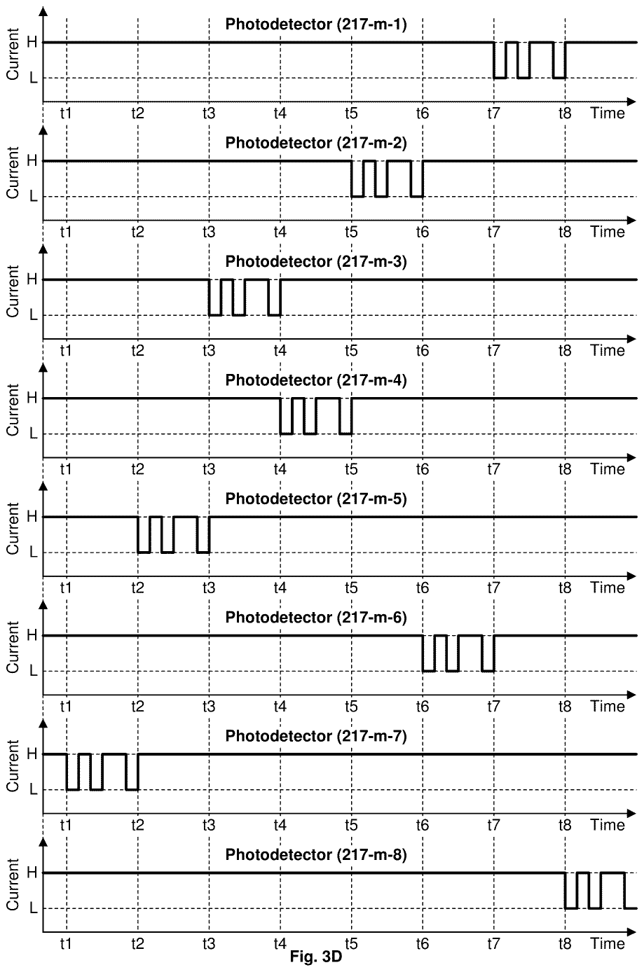

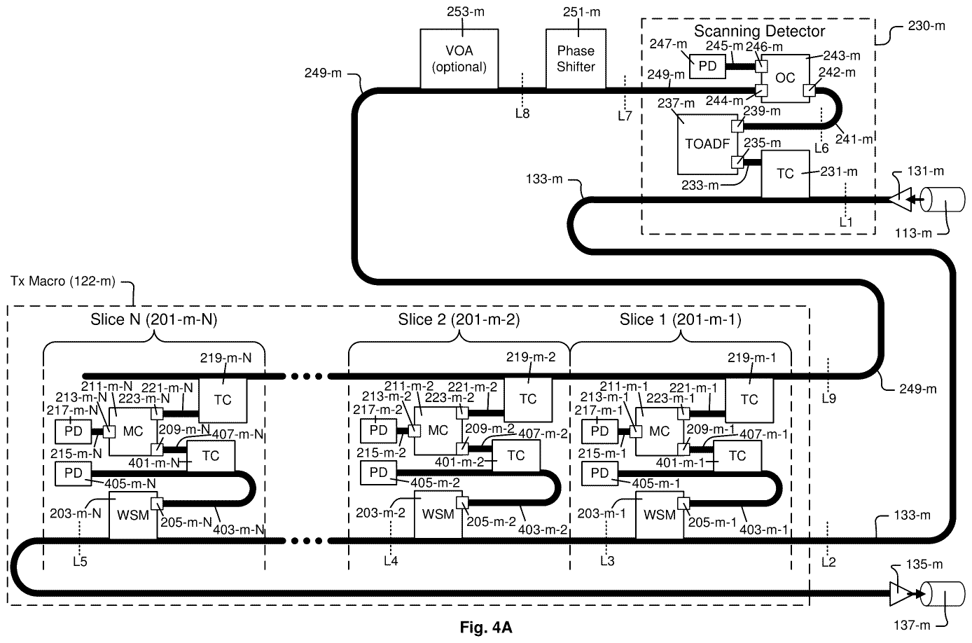

FIG. 3A shows the optical conveyance through the transmit bus optical waveguide 133-m at each of locations L1, L2, L3, L4, and L5, as referenced in FIG. 2A, in an example embodiment in which the transmit macro 122-m includes eight transmit slices 201-m-1 to 201-m-8, in accordance with some embodiments. FIG. 3A shows how CW light of each wavelength (λ₁ to λ_{N}) is conveyed through the transmit bus optical waveguide 133-m at each of times t1 to t8 during a resonance wavelength mapping for the wavelength selective modulators 203-m-1 to 203-m-N.

FIG. 3B shows the optical conveyance through the mapping bus optical waveguide 249-m at each of locations L6, L7, L8, and L9, as referenced in FIG. 2A, in the example embodiment in which the transmit macro 122-m includes eight transmit slices 201-m-1 to 201-m-8, in accordance with some embodiments. FIG. 3B shows an example of how the tunable resonance wavelength of the tunable optical add/drop filter 237-m is scanned over wavelengths (λ₁ to λ_{N}) over times t1 to t8 during the resonance wavelength mapping for the wavelength selective modulators 203-m-1 to 203-m-N. Specifically, FIG. 3B shows that at time t1, the resonance wavelength of the tunable optical add/drop filter 237-m is tuned to the wavelength λ₁, such that the mapping light within the mapping bus optical waveguide 249-m has the wavelength λ₁ at time t1. Then, at time t2, the resonance wavelength of the tunable optical add/drop filter 237-m is tuned to the wavelength λ₂, such that the mapping light within the mapping bus optical waveguide 249-m has the wavelength λ₂ at time t2. Then, at time t3, the resonance wavelength of the tunable optical add/drop filter 237-m is tuned to the wavelength λ₃, such that the mapping light within the mapping bus optical waveguide 249-m has the wavelength λ₃ at time t3. Then, at time t4, the resonance wavelength of the tunable optical add/drop filter 237-m is tuned to the wavelength λ₄, such that the mapping light within the mapping bus optical waveguide 249-m has the wavelength λ₄ at time t4. Then, at time t5, the resonance wavelength of the tunable optical add/drop filter 237-m is tuned to the wavelength λ₅, such that the mapping light within the mapping bus optical waveguide 249-m has the wavelength λ₅ at time t5. Then, at time t6, the resonance wavelength of the tunable optical add/drop filter 237-m is tuned to the wavelength λ₆, such that the mapping light within the mapping bus optical waveguide 249-m has the wavelength λ₆ at time t6. Then, at time t7, the resonance wavelength of the tunable optical add/drop filter 237-m is tuned to the wavelength λ₇, such that the mapping light within the mapping bus optical waveguide 249-m has the wavelength λ₇ at time t7. Then, at time t8, the resonance wavelength of the tunable optical add/drop filter 237-m is tuned to the wavelength λ₈, such that the mapping light within the mapping bus optical waveguide 249-m has the wavelength λ₈ at time t8. It should be understood that the scanning of the resonance wavelength of the tunable optical add/drop filter 237-m in the monotonically increasing manner as depicted in FIG. 3B is provided by way of example. In other embodiments, the resonance wavelength of the tunable optical add/drop filter 237-m is scanned in a different sequence or manner than what is shown in the example of FIG. 3B. Also, in some embodiments, the duration over which a given resonance wavelength of the tunable optical add/drop filter 237-m is held during the scanning of the resonance wavelength of the tunable optical add/drop filter 237-m over the wavelengths (λ₁ to λ_{N}) is adjustable as needed to support the algorithm for mapping out the resonant wavelengths of the wavelength selective modulators 203-m-1 to 203-m-N.

FIG. 3C shows the photocurrents generated by the mapping photodetectors 217-m-1 to 217-m-8 during the resonance wavelength mapping for the wavelength selective modulators 203-m-1 to 203-m-N for the example optical conveyances shown in FIGS. 3A and 3B, in accordance with some embodiments. At time t1, the wavelength of the mapping light is λ₁, as shown in FIG. 3B. At time t1, the mapping photodetector 217-m-1 shows the perturbations in the amplitude of the generated photocurrent corresponding to the phase modulation pattern imparted onto the mapping light by the phase shifter 251-m, while the generated photocurrents of the other mapping photodetectors 217-m-2 to 217-m-8 at time t1 do not show any perturbations indicative of the phase modulation pattern imparted onto the mapping light by the phase shifter 251-m. Therefore, monitoring of the photocurrents of the mapping photodetectors 217-m-1 to 217-m-8 at time t1 shows that the wavelength selective modulator 203-m-1 of the transmit slice 201-m-1 is tuned and mapped to the wavelength λ₁.

At time t2, the wavelength of the mapping light is λ₂, as shown in FIG. 3B. At time t2, the mapping photodetector 217-m-2 shows the perturbations in the amplitude of the generated photocurrent corresponding to the phase modulation pattern imparted onto the mapping light by the phase shifter 251-m, while the generated photocurrents of the other mapping photodetectors 217-m-1 and 217-m-3 to 217-m-8 at time t2 do not show any perturbations indicative of the phase modulation pattern imparted onto the mapping light by the phase shifter 251-m. Therefore, monitoring of the photocurrents of the mapping photodetectors 217-m-1 to 217-m-8 at time t2 shows that the wavelength selective modulator 203-m-2 of the transmit slice 201-m-2 is tuned and mapped to the wavelength λ₂.

At time t3, the wavelength of the mapping light is λ₃, as shown in FIG. 3B. At time t3, the mapping photodetector 217-m-3 shows the perturbations in the amplitude of the generated photocurrent corresponding to the phase modulation pattern imparted onto the mapping light by the phase shifter 251-m, while the generated photocurrents of the other mapping photodetectors 217-m-1 to 217-m-2 and 217-m-4 to 217-m-8 at time t3 do not show any perturbations indicative of the phase modulation pattern imparted onto the mapping light by the phase shifter 251-m. Therefore, monitoring of the photocurrents of the mapping photodetectors 217-m-1 to 217-m-8 at time t3 shows that the wavelength selective modulator 203-m-3 of the transmit slice 201-m-3 is tuned and mapped to the wavelength λ₃.

At time t4, the wavelength of the mapping light is λ₄, as shown in FIG. 3B. At time t4, the mapping photodetector 217-m-4 shows the perturbations in the amplitude of the generated photocurrent corresponding to the phase modulation pattern imparted onto the mapping light by the phase shifter 251-m, while the generated photocurrents of the other mapping photodetectors 217-m-1 to 217-m-3 and 217-m-5 to 217-m-8 at time t4 do not show any perturbations indicative of the phase modulation pattern imparted onto the mapping light by the phase shifter 251-m. Therefore, monitoring of the photocurrents of the mapping photodetectors 217-m-1 to 217-m-8 at time t4 shows that the wavelength selective modulator 203-m-4 of the transmit slice 201-m-4 is tuned and mapped to the wavelength λ₄.

At time t5, the wavelength of the mapping light is λ₅, as shown in FIG. 3B. At time t5, the mapping photodetector 217-m-5 shows the perturbations in the amplitude of the generated photocurrent corresponding to the phase modulation pattern imparted onto the mapping light by the phase shifter 251-m, while the generated photocurrents of the other mapping photodetectors 217-m-1 to 217-m-4 and 217-m-6 to 217-m-8 at time t5 do not show any perturbations indicative of the phase modulation pattern imparted onto the mapping light by the phase shifter 251-m. Therefore, monitoring of the photocurrents of the mapping photodetectors 217-m-1 to 217-m-8 at time t5 shows that the wavelength selective modulator 203-m-5 of the transmit slice 201-m-5 is tuned and mapped to the wavelength λ₅.

At time t6, the wavelength of the mapping light is λ₆, as shown in FIG. 3B. At time t6, the mapping photodetector 217-m-6 shows the perturbations in the amplitude of the generated photocurrent corresponding to the phase modulation pattern imparted onto the mapping light by the phase shifter 251-m, while the generated photocurrents of the other mapping photodetectors 217-m-1 to 217-m-5 and 217-m-7 to 217-m-8 at time t6 do not show any perturbations indicative of the phase modulation pattern imparted onto the mapping light by the phase shifter 251-m. Therefore, monitoring of the photocurrents of the mapping photodetectors 217-m-1 to 217-m-8 at time t6 shows that the wavelength selective modulator 203-m-6 of the transmit slice 201-m-6 is tuned and mapped to the wavelength λ₆.

At time t7, the wavelength of the mapping light is λ₇, as shown in FIG. 3B. At time t7, the mapping photodetector 217-m-7 shows the perturbations in the amplitude of the generated photocurrent corresponding to the phase modulation pattern imparted onto the mapping light by the phase shifter 251-m, while the generated photocurrents of the other mapping photodetectors 217-m-1 to 217-m-6 and 217-m-8 at time t7 do not show any perturbations indicative of the phase modulation pattern imparted onto the mapping light by the phase shifter 251-m. Therefore, monitoring of the photocurrents of the mapping photodetectors 217-m-1 to 217-m-8 at time t7 shows that the wavelength selective modulator 203-m-7 of the transmit slice 201-m-7 is tuned and mapped to the wavelength λ₇.

At time t8, the wavelength of the mapping light is λ₈, as shown in FIG. 3B. At time t8, the mapping photodetector 217-m-8 shows the perturbations in the amplitude of the generated photocurrent corresponding to the phase modulation pattern imparted onto the mapping light by the phase shifter 251-m, while the generated photocurrents of the other mapping photodetectors 217-m-1 to 217-m-76 at time t8 do not show any perturbations indicative of the phase modulation pattern imparted onto the mapping light by the phase shifter 251-m. Therefore, monitoring of the photocurrents of the mapping photodetectors 217-m-1 to 217-m-8 at time t8 shows that the wavelength selective modulator 203-m-8 of the transmit slice 201-m-8 is tuned and mapped to the wavelength λ₈.

In some embodiments, such as shown in FIGS. 3A, 3B, and 3C, the resonance wavelengths of the wavelength selective modulators 203-m-1 to 203-m-N of the transmit macro 122-m are tuned in a monotonically increasing manner, such that the resonance wavelength of the wavelength selective modulator 203-m-1 of the first transmit slice 201-m-1 is tuned to the lowest wavelength of λ₁, and the resonance wavelength of the wavelength selective modulator 203-m-N of the N^{th} transmit slice 201-m-N is tuned to the highest wavelength of λ_{N}, with the intervening resonance wavelengths of the wavelength selective modulators 203-m-2 to 203-m-(N-1) of the transmit slices 201-m-2 to 201-m-(N-1) tuned to have monotonically increasing wavelengths of λ₂ to λ_{N-1}. However, it should be understood that in some embodiments the resonance wavelengths of the wavelength selective modulators 203-m-1 to 203-m-N of the transmit macro 122-m are tuned in an arbitrary sequence across the transmit slices 201-m-1 to 201-m-N.

FIG. 3D shows the photocurrents generated by the mapping photodetectors 217-m-1 to 217-m-8 during the resonance wavelength mapping for the wavelength selective modulators 203-m-1 to 203-m-N for the example optical conveyances shown in FIGS. 3A and 3B, in which the wavelength selective modulators 203-m-1 to 203-m-N have a non-sequential ordering across the transmit macro 122-m, in accordance with some embodiments. At time t1, the wavelength of the mapping light is λ₁, as shown in FIG. 3B. At time t1, the mapping photodetector 217-m-7 shows the perturbations in the amplitude of the generated photocurrent corresponding to the phase modulation pattern imparted onto the mapping light by the phase shifter 251-m, while the generated photocurrents of the other mapping photodetectors 217-m-1 to 217-m-6 and 217-m-8 at time t1 do not show any perturbations indicative of the phase modulation pattern imparted onto the mapping light by the phase shifter 251-m. Therefore, monitoring of the photocurrents of the mapping photodetectors 217-m-1 to 217-m-8 at time t1 shows that the wavelength selective modulator 203-m-7 of the transmit slice 201-m-7 is tuned and mapped to the wavelength λ₁.

At time t2, the wavelength of the mapping light is λ₂, as shown in FIG. 3B. At time t2, the mapping photodetector 217-m-5 shows the perturbations in the amplitude of the generated photocurrent corresponding to the phase modulation pattern imparted onto the mapping light by the phase shifter 251-m, while the generated photocurrents of the other mapping photodetectors 217-m-1 to 217-m-4 and 217-m-6 to 217-m-8 at time t2 do not show any perturbations indicative of the phase modulation pattern imparted onto the mapping light by the phase shifter 251-m. Therefore, monitoring of the photocurrents of the mapping photodetectors 217-m-1 to 217-m-8 at time t2 shows that the wavelength selective modulator 203-m-5 of the transmit slice 201-m-5 is tuned and mapped to the wavelength λ₂.

At time t3, the wavelength of the mapping light is λ₃, as shown in FIG. 3B. At time t3, the mapping photodetector 217-m-3 shows the perturbations in the amplitude of the generated photocurrent corresponding to the phase modulation pattern imparted onto the mapping light by the phase shifter 251-m, while the generated photocurrents of the other mapping photodetectors 217-m-1 to 217-m-2 and 217-m-4 to 217-m-8 at time t3 do not show any perturbations indicative of the phase modulation pattern imparted onto the mapping light by the phase shifter 251-m. Therefore, monitoring of the photocurrents of the mapping photodetectors 217-m-1 to 217-m-8 at time t3 shows that the wavelength selective modulator 203-m-3 of the transmit slice 201-m-3 is tuned and mapped to the wavelength λ₃.

At time t4, the wavelength of the mapping light is λ₄, as shown in FIG. 3B. At time t4, the mapping photodetector 217-m-4 shows the perturbations in the amplitude of the generated photocurrent corresponding to the phase modulation pattern imparted onto the mapping light by the phase shifter 251-m, while the generated photocurrents of the other mapping photodetectors 217-m-1 to 217-m-3 and 217-m-5 to 217-m-8 at time t4 do not show any perturbations indicative of the phase modulation pattern imparted onto the mapping light by the phase shifter 251-m. Therefore, monitoring of the photocurrents of the mapping photodetectors 217-m-1 to 217-m-8 at time t4 shows that the wavelength selective modulator 203-m-4 of the transmit slice 201-m-4 is tuned and mapped to the wavelength λ₄.

At time t5, the wavelength of the mapping light is λ₅, as shown in FIG. 3B. At time t5, the mapping photodetector 217-m-2 shows the perturbations in the amplitude of the generated photocurrent corresponding to the phase modulation pattern imparted onto the mapping light by the phase shifter 251-m, while the generated photocurrents of the other mapping photodetectors 217-m-1 and 217-m-3 to 217-m-8 at time t5 do not show any perturbations indicative of the phase modulation pattern imparted onto the mapping light by the phase shifter 251-m. Therefore, monitoring of the photocurrents of the mapping photodetectors 217-m-1 to 217-m-8 at time t5 shows that the wavelength selective modulator 203-m-2 of the transmit slice 201-m-2 is tuned and mapped to the wavelength λ₅.

At time t6, the wavelength of the mapping light is λ₆, as shown in FIG. 3B. At time t6, the mapping photodetector 217-m-6 shows the perturbations in the amplitude of the generated photocurrent corresponding to the phase modulation pattern imparted onto the mapping light by the phase shifter 251-m, while the generated photocurrents of the other mapping photodetectors 217-m-1 to 217-m-5 and 217-m-7 to 217-m-8 at time t6 do not show any perturbations indicative of the phase modulation pattern imparted onto the mapping light by the phase shifter 251-m. Therefore, monitoring of the photocurrents of the mapping photodetectors 217-m-1 to 217-m-8 at time t6 shows that the wavelength selective modulator 203-m-6 of the transmit slice 201-m-6 is tuned and mapped to the wavelength λ₆.

At time t7, the wavelength of the mapping light is λ₇, as shown in FIG. 3B. At time t7, the mapping photodetector 217-m-1 shows the perturbations in the amplitude of the generated photocurrent corresponding to the phase modulation pattern imparted onto the mapping light by the phase shifter 251-m, while the generated photocurrents of the other mapping photodetectors 217-m-2 to 217-m-8 at time t7 do not show any perturbations indicative of the phase modulation pattern imparted onto the mapping light by the phase shifter 251-m. Therefore, monitoring of the photocurrents of the mapping photodetectors 217-m-1 to 217-m-8 at time t7 shows that the wavelength selective modulator 203-m-1 of the transmit slice 201-m-1 is tuned and mapped to the wavelength λ₇.

At time t8, the wavelength of the mapping light is λ₈, as shown in FIG. 3B. At time t8, the mapping photodetector 217-m-8 shows the perturbations in the amplitude of the generated photocurrent corresponding to the phase modulation pattern imparted onto the mapping light by the phase shifter 251-m, while the generated photocurrents of the other mapping photodetectors 217-m-1 to 217-m-76 at time t8 do not show any perturbations indicative of the phase modulation pattern imparted onto the mapping light by the phase shifter 251-m. Therefore, monitoring of the photocurrents of the mapping photodetectors 217-m-1 to 217-m-8 at time t8 shows that the wavelength selective modulator 203-m-8 of the transmit slice 201-m-8 is tuned and mapped to the wavelength λ₈. Based on the example of FIG. 3D, it should be understood that in some embodiments the resonance wavelengths of the wavelength selective modulators 203-m-1 to 203-m-N of the transmit macro 122-m are tuned in an arbitrary sequence, or a specific non-monotonic sequence, across the transmit slices 201-m-1 to 201-m-N.

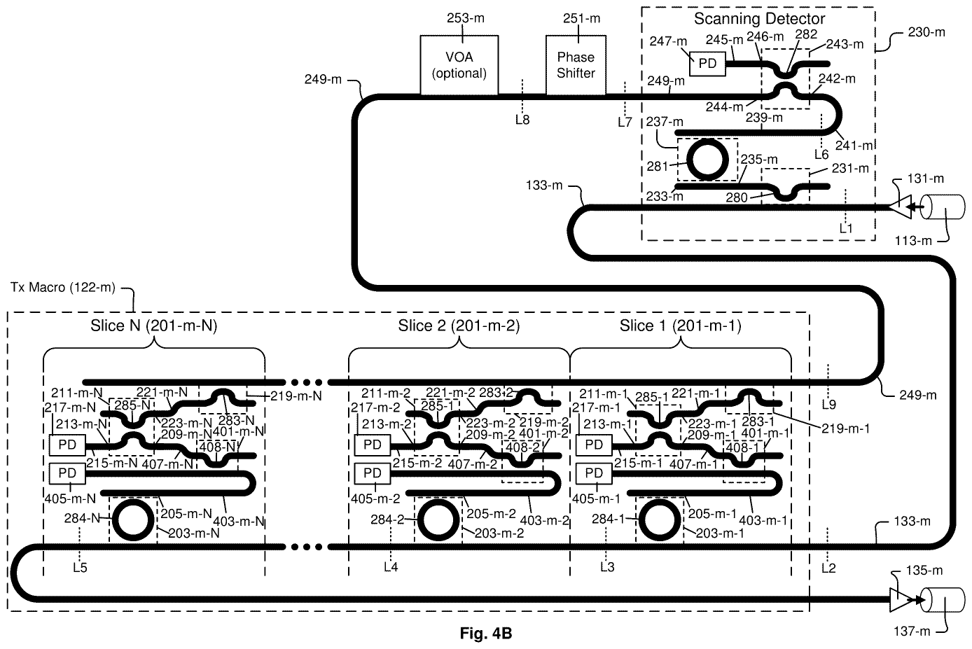

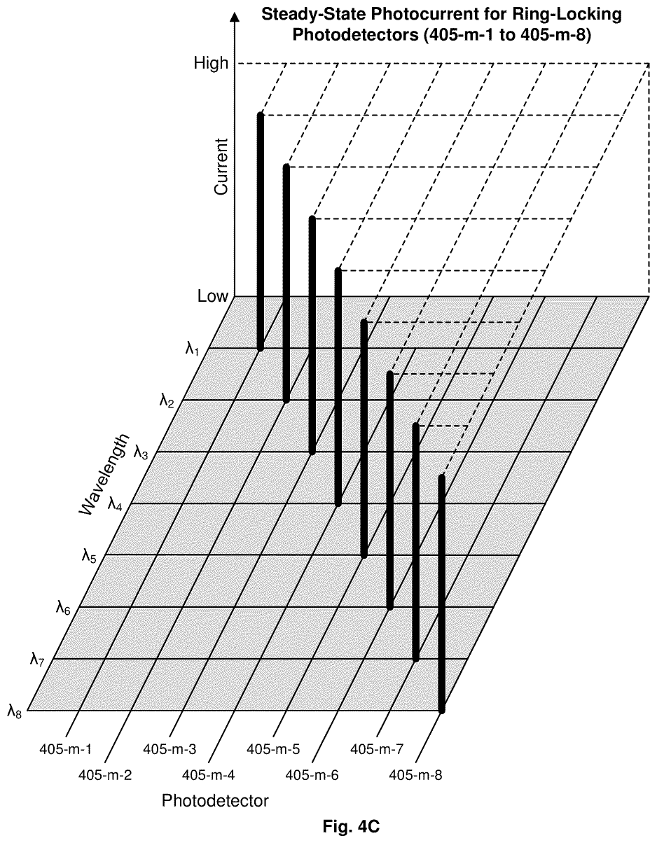

FIG. 4A shows a variant of the transmit macro 122-m of FIG. 2A in which each transmit slice 201-m-1 to 201-m-N is modified to include a respective one of a plurality of ring locking photodetectors 405-m-1 to 405-m-N that are implemented separately from the corresponding mapping photodetectors 217-m-1 to 217-m-N, respectively, in accordance with some embodiments. Each feature of FIGS. 2A and 4A that has the same reference numeral is the same feature and functions in the same manner as described with regard to FIG. 2A. In the embodiment of FIG. 4A, each transmit slice 201-m-s, where s is any of 1 to N, includes a drop optical waveguide 403-m-s optically connected to the optical drop port 205-m-s of the wavelength selective modulators 203-m-s. The drop optical waveguide 403-m-s is optically connected to the corresponding ring locking photodetectors 405-m-s, such that a portion of the drop light conveyed through the optical drop port 205-m-s of the wavelength selective modulators 203-m-s is conveyed to the ring locking photodetectors 405-m-s by way of the drop optical waveguide 403-m-s. Also, each transmit slice 201-m-s includes an optical tap coupler (TC) 401-m-s that is optically coupled to the drop optical waveguide 403-m-s. The optical tap coupler 401-m-s is configured to function as an optical power tap that diverts a portion of the optical power in the drop optical waveguide 403-m-s, regardless of wavelength, into the first optical input port 209-m-s of the corresponding mapping coupler 211-m-s by way of an optical waveguide 407-m-s. In this embodiment, the ring locking photodetector 405-m-s of transmit slice 201-m-s is operated independently from the mapping photodetector 217-m-s. Implementation of the ring locking photodetector 405-m-s provides for a clear monitoring of the optical power within the corresponding wavelength selective modulators 203-m-s at a given time, without any possibility of disturbance from optical signals conveyed through the mapping bus optical waveguide 249-m.

FIG. 4B shows an example implementation of the transmit macro 122-m of FIG. 4A, in accordance with some embodiments. Each feature of FIGS. 2B and 4B that has the same reference numeral is the same feature and functions in the same manner as described with regard to FIG. 2B. Also, in the example of FIG. 4B, the optical tap couplers 401-m-1 to 401-m-N are implemented as evanescent taps 408-1 to 408-N, respectively, each of which is configured to direct a portion of the optical power within the drop optical waveguide 403-m-1 to 403-m-N, respectively, to the corresponding one of the mapping couplers 211-m-1 to 211-m-N, respectively.

FIG. 4C shows the steady-state photocurrents generated by the ring locking photodetectors 405-m-1 to 405-m-8 during the resonance wavelength mapping for the wavelength selective modulators 203-m-1 to 203-m-N for the example optical conveyances shown in FIGS. 3A and 3B, in accordance with some embodiments. As shown in FIG. 4C, the photocurrents generated by the ring locking photodetectors 405-m-1 to 405-m-8 indicate that each of the wavelength selective modulators 203-m-1 to 203-m-N is locked onto one of the resonance wavelengths (λ₁ to λ₈), respectively.

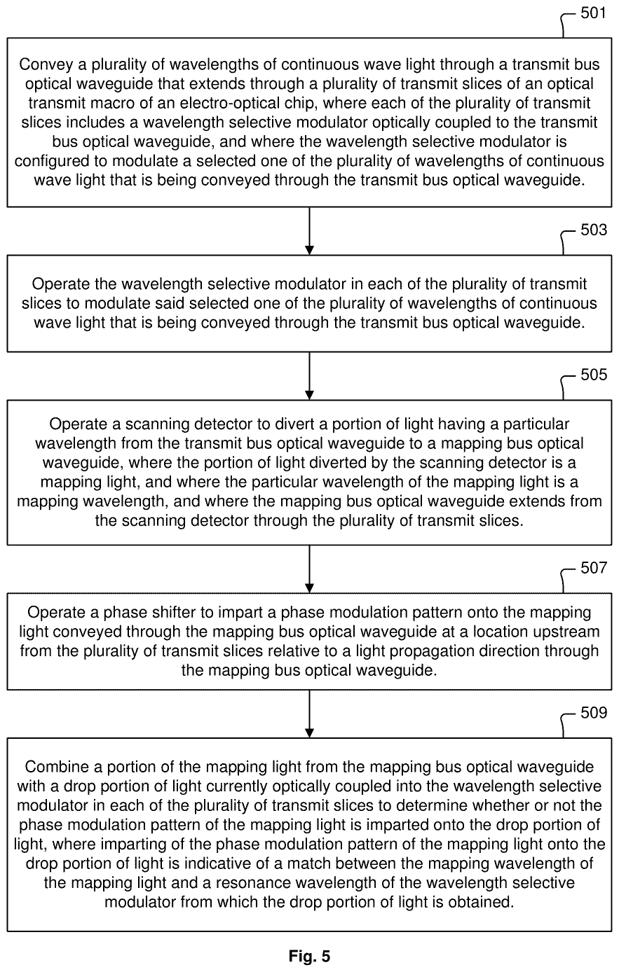

FIG. 5 shows a flowchart of a method for mapping resonance wavelengths of wavelength selective modulators 203-m-1 to 203-m-N across the optical transmit macro 122-m of the electro-optical chip 102, in accordance with some embodiments. The method of FIG. 5 is performed by the transmit macro 122-m described with regard to FIG. 2A/2B and 4A/4B. The method includes an operation 501 for conveying the plurality of wavelengths (λ₁ to λ_{N}) of CW light through the transmit bus optical waveguide 133-m that extends through the plurality of transmit slices 201-m-1 to 201-m-N of the optical transmit macro 122-m of the electro-optical chip 102. Each of the plurality of transmit slices 201-m-1 to 201-m-N includes a wavelength selective modulator 203-m-1 to 203-m-N optically coupled to the transmit bus optical waveguide 133-m. The wavelength selective modulator 203-m-1 to 203-m-N is configured to modulate a selected one of the plurality of wavelengths (λ₁ to λ_{N}) of CW light that is being conveyed through the transmit bus optical waveguide 133-m. The method also includes an operation 503 for operating the wavelength selective modulator 203-m-1 to 203-m-N in each of the plurality of transmit slices 201-m-1 to 201-m-N to modulate said selected one of the plurality of wavelengths (λ₁ to λ_{N}) of CW light that is being conveyed through the transmit bus optical waveguide 133-m. The method also includes an operation 505 for operating the scanning detector 230-m to divert a portion of light having a particular wavelength from the transmit bus optical waveguide 133-m to the mapping bus optical waveguide 249-m. The portion of light diverted by the scanning detector 230-m is a mapping light. The particular wavelength of the mapping light is a mapping wavelength. The mapping bus optical waveguide 249-m extends from the scanning detector 230-m through the plurality of transmit slices 201-m-1 to 201-m-N. In some embodiments, operating the scanning detector 230-m includes operating the tunable optical add/drop filter 237-m to divert the mapping light having the mapping wavelength from the transmit bus optical waveguide 133-m to the mapping bus optical waveguide 249-m. The method also includes an operation 507 for operating the phase shifter 251-m to impart a phase modulation pattern onto the mapping light conveyed through the mapping bus optical waveguide 249-m at a location upstream from the plurality of transmit slices 201-m-1 to 201-m-N relative to a light propagation direction through the mapping bus optical waveguide 249-m. The method also includes an operation 509 for combining a portion of the mapping light from the mapping bus optical waveguide 249-m with a drop portion of light currently optically coupled into the wavelength selective modulator 203-m-1 to 203-m-N in each of the plurality of transmit slices 201-m-1 to 201-m-N to determine whether or not the phase modulation pattern of the mapping light is imparted onto the drop portion of light. Imparting of the phase modulation pattern of the mapping light onto the drop portion of light is indicative of a match between the mapping wavelength of the mapping light and a resonance wavelength of the wavelength selective modulator 203-m-1 to 203-m-N from which the drop portion of light is obtained.

In some embodiments, the method includes operating the scanning detector 230-m to divert different portions of light having different mapping wavelengths from the transmit bus optical waveguide 133-m until the resonance wavelength of each wavelength selective modulator 203-m-1 to 203-m-N within the plurality of transmit slices 201-m-1 to 201-m-N is matched to one of the different mapping wavelengths. In some embodiments, the method includes operating the variable optical attenuator 253-m that is optically coupled to the mapping bus optical waveguide 249-m to control an optical power within the mapping bus optical waveguide 249-m upstream of the plurality of transmit slices 201-m-1 to 201-m-N relative to a light propagation direction through the mapping bus optical waveguide 249-m.

In some embodiments, the operation 509 for combining the portion of the mapping light from the mapping bus optical waveguide 249-m with the drop portion of light currently optically coupled into the wavelength selective modulator 203-m-1 to 203-m-N is done by operating a mapping coupler 211-m-1 to 211-m-N that receives the mapping light and the drop portion of light as inputs and that conveys an optical output signal to the photodetector 217-m-1 to 217-m-N. In these embodiments, the method also includes monitoring a photocurrent generated by the photodetector 217-m-1 to 217-m-N to determine when an amplitude variation of the optical output signal indicates that the mapping light is imparted onto the drop portion of light due to the mapping wavelength matching the resonance wavelength of the wavelength selective modulator 203-m-1 to 203-m-N from which the drop portion of light is obtained. In some embodiments, the photodetector 217-m-1 to 217-m-N to which the optical output signal is conveyed from the mapping coupler 211-m-1 to 211-m-N is a mapping photodetector 217-m-1 to 217-m-N. In these embodiments, the method also includes conveying some of the drop portion of light into the ring locking photodetector 405-m-1 to 405-m-N to facilitate locking of the resonance wavelength of the wavelength selective modulator 203-m-1 to 203-m-N. In these embodiments, the mapping photodetector 217-m-1 to 217-m-N and the ring locking photodetector 405-m-1 to 405-m-N are operated independently of each other.

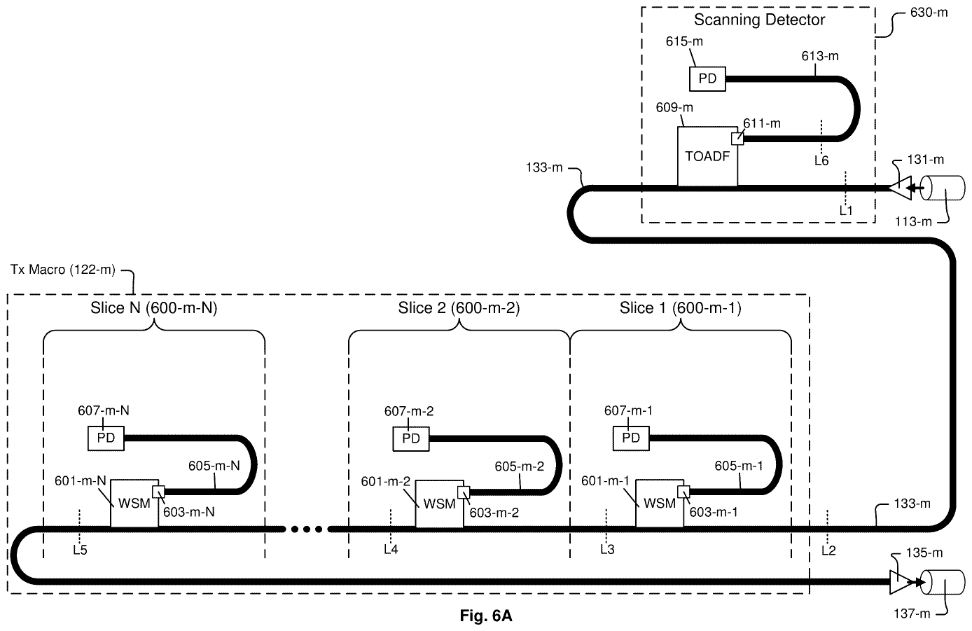

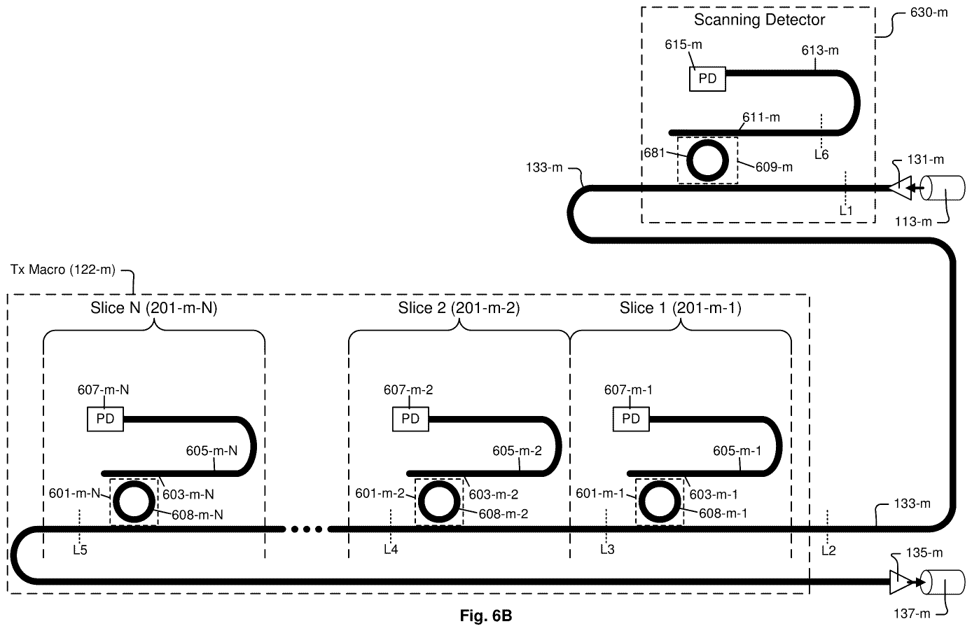

FIG. 6A shows a transmit macro 122-m configured to provide for monitoring of relative changes in optical power and optical wavelength for each of N wavelengths (λ₁ to λ_{N}) of CW light injected into the transmit macro 122-m, by way of the optical supply input 131-m, in order to determine a modulator-to-wavelength mapping for the transmit macro 122-m, in accordance with some embodiments. It should be understood that the transmit macro 122-m of FIG. 6A, where m is 1 to M, can be implemented as any one of the transmit macros 122-1 to 122-M in the electro-optical chip 102 described with regard to FIG. 1C. A scanning detector 630-m, for the macro m, is disposed between the optical supply input 131-m and the transmit macro 122-m. The scanning detector 630-m includes a tunable optical add/drop filter (TOADF) 609-m optically coupled to the transmit bus optical waveguide 133-m. The tunable optical add/drop filter 609-m is configured to have a tunable resonance wavelength. The tunable optical add/drop filter 609-m is configured to convey light from the transmit bus optical waveguide 133-m that has a wavelength equal to the current setting of the tunable resonance wavelength through an optical output port 611-m of the tunable optical add/drop filter 609-m. The current setting of the tunable resonance wavelength of the tunable optical add/drop filter 609-m is referred to as the mapping wavelength. The light that has the mapping wavelength that is conveyed through the optical output port 611-m of the tunable optical add/drop filter 609-m is referred to as the mapping light.

In various embodiments, the tunable optical add/drop filter 609-m is implemented in various ways. For example, in some embodiments, the tunable optical add/drop filter 609-m is implemented as one or more of ring resonators, photonic crystal resonators, and Bragg gratings, among others. In some embodiments, the tunable optical add/drop filter 609-m includes multiple resonators to achieve the desired transfer function. For example, in some embodiments, the tunable optical add/drop filter 609-m includes multiple resonators placed in series along a common bus waveguide, coupled together to create a higher order filter, or implemented in a Vernier configuration to increase the effective free spectral range. In some embodiments, the tunable optical add/drop filter 609-m implements an electrical tuning mechanism for changing the resonance wavelength of the tunable optical add/drop filter 609-m. For example, in some embodiments, the tunable optical add/drop filter 609-m implements a thermo-optic tuning mechanism in which electrical current is driven through a nearby conductive structure to heat the tunable optical add/drop filter 609-m and correspondingly shift the resonance wavelength of the tunable optical add/drop filter 609-m, thereby enabling control of the mapping wavelength. The scanning detector 630-m also includes an optical waveguide 613-m that is optically connected to the optical output port 611-m (drop port 611-m) of the tunable optical add/drop filter 609-m. The optical waveguide 613-m conveys the mapping light to a photodetector (PD) 615-m of the scanning detector 630-m.

As the tunable optical add/drop filter 609-m is tuned, a photocurrent is generated in the photodetector 615-m as the resonance wavelength of the tunable optical add/drop filter 609-m scans across any of the wavelengths (λ₁ to λ_{N}) of CW light that are conveyed into the transmit bus optical waveguide 133-m from the optical supply input 131-m. The photocurrent in the photodetector 615-m corresponds to the optical power of a given one of the wavelengths (λ₁ to λ_{N}). The electrical power that is used to tune the tunable optical add/drop filter 609-m at a given time corresponds to the resonance wavelength of the tunable optical add/drop filter 609-m at the given time. Tracking the photocurrent of the photodetector 615-m as a function of the electrical power used to tune the tunable optical add/drop filter 609-m provides information about the relative wavelengths (λ₁ to λ_{N}) at which optical power exists in the transmit bus optical waveguide 133-m. Therefore, for embodiments that use electrical heater power to adjust the resonance wavelength of the tunable optical add/drop filter 609-m, tracking of the photocurrent of the photodetector 615-m as a function of the electrical power used to tune the tunable optical add/drop filter 609-m effectively provides a spectrum of photodetector 615-m photocurrent versus heater power, which is then calibrated to extract optical power in the transmit bus optical waveguide 133-m as a function of wavelength for each of the wavelengths (λ₁ to λ_{N}). In these embodiments, by continuously scanning of the resonance wavelength of the tunable optical add/drop filter 609-m across all of the wavelengths (λ₁ to λ_{N}) of CW light in the transmit bus optical waveguide 133-m, time-dependent information is obtained about relative changes/drift in both the optical power and wavelength of all the optical source wavelengths (λ₁ to λ_{N}) of CW light conveyed into the in the transmit bus optical waveguide 133-m.

The transmit macro 122-m includes a number N of transmit slices 600-m-1 to 600-m-N. The transmit bus optical waveguide 133-m extends through each of the transmit slices 600-m-1 to 600-m-N, and then to the optical signal output 135-m of the transmit macro 122-m. Each of the transmit slices 600-m-1 to 600-m-N includes a respective wavelength selective modulator (WSM) 601-m-1 to 601-m-N that is optically coupled to the transmit bus optical waveguide 133-m. Each of the wavelength selective modulators 601-m-1 to 601-m-N is configured to modulate CW light of a particular wavelength propagating through the transmit bus optical waveguide 133-m. In some embodiments, each of the wavelength selective modulators 603-m-1 to 603-m-N is tunable to operate at the particular wavelength, such as by thermal resonance wavelength tuning. In various embodiments, each of the wavelength selective modulators 603-m-1 to 603-m-N includes one or more of a microring modulator, Mach-Zehnder modulator (MZM), ring-assisted Mach-Zehnder interferometric (RAMZI) modulator, ring-assisted Mach-Zehnder modulator (RAMZM), electro-absorption modulator (EAM), or other type of integrated optical modulator known in the optical data communication industry.

Each particular one of the wavelength selective modulators 601-m-1 to 601-m-N includes an optical drop port 603-m-1 to 205-m-N, respectively, through which is conveyed a portion of the light that is currently coupled into the particular one of the wavelength selective modulators 600-m-1 to 600-m-N. Each transmit slice 600-m-1 to 600-m-N includes a photodetector 607-m-1 to 607-m-N, respectively. For a given transmit slice 600-m-s, where(s) is any of 1 to N, the optical drop port 603-m-s of the corresponding wavelength selective modulator 601-m-s is optically connected to an optical waveguide 605-m-s. The portion of the light that is currently conveyed through the optical drop port 603-m-s of the wavelength selective modulator 601-m-s is conveyed through the optical waveguide 605-m-s to the corresponding photodetector 607-m-s.

FIG. 6B shows an example implementation of the transmit macro 122-m of FIG. 6A, in accordance with some embodiments. Each feature of FIGS. 6A and 6B that has the same reference numeral is the same feature and functions in the same manner as described with regard to FIG. 6A. In the example of FIG. 6B, the tunable optical add/drop filter 609-m is implemented as microring resonator 681 that is resonance wavelength tunable, such as through control of a temperature of the microring resonator 681. Also, in the example of FIG. 6B, the wavelength selective modulators 601-m-1 to 601-m-N are implemented as evanescent taps 608-1 to 608-N, respectively, each of which is configured to direct a portion of the optical power conveyed within the transmit bus optical waveguide 133-m to the corresponding one of the photodetectors 607-m-1 to 607-1-N, respectively, by way of the corresponding one of the optical waveguides 605-m-1 to 605-m-N, respectively. The wavelength selective modulators 601-m-1 to 601-m-N are resonance wavelength tunable, such as through control of their temperature.

The transmit macro 122-m and scanning detector 630-m of FIGS. 6A and 6B provides for monitoring of relative changes in optical power and optical wavelength for each of the N wavelengths (λ₁ to λ_{N}) injected into the transmit bus optical waveguide 133-m. The transmit macro 122-m and scanning detector 630-m of FIGS. 6A and 6B also provides for obtaining the wavelength mapping of the wavelength selective modulators 601-m-1 to 601-m-N for the transmit macro 122-m. As the resonance wavelength of the tunable optical add/drop filter 609-m is changed, a photocurrent is generated in the photodetector 615-m when the resonance wavelength of the tunable optical add/drop filter 609-m matches any of the N wavelengths (λ₁ to λ_{N}) of the CW light that are conveyed into the transmit bus optical waveguide 133-m. The photocurrent generated in the photodetector 615-m at a given time corresponds to the optical power of one of the N wavelengths (λ₁ to λ_{N}) of CW light within the transmit bus optical waveguide 133-m at the given time. The electrical power that is used to tune the tunable optical add/drop filter 609-m corresponds to the resonance wavelength of the tunable optical add/drop filter 609-m. Tracking of the photocurrent generated in the photodetector 615-m versus the tuning power applied to the tunable optical add/drop filter 609-m provides information about the relative wavelength at which optical power currently exists in the transmit bus optical waveguide 133-m.

In each of the transmit slices 600-m-1 to 600-m-N, the drop port 603-m-1 to 603-m-N of the corresponding wavelength selective modulators 601-m-1 to 601-m-N is connected to the corresponding photodetector 607-m-1 to 607-m-N. If the current resonance wavelength of the wavelength selective modulator 601-m-s, where s is any of 1 to N, overlaps with one of the N wavelengths (λ₁ to λ_{N}) of CW light within the transmit bus optical waveguide 133-m, the photocurrent generated by the corresponding photodetector 607-m-s will drop whenever the tunable optical add/drop filter 609-m of the scanning detector 630-m scans across the current resonance wavelength of the wavelength selective modulator 601-m-s. More specifically, when the resonance wavelength of the tunable optical add/drop filter 609-m of the scanning detector 630-m matches the resonance wavelength of one of the wavelength selective modulators 601-m-1 to 601-m-N, the photocurrent generated by the corresponding one of the photodetectors 607-m-1 to 607-m-N will drop due to the diversion of optical power at that resonance wavelength from the transmit bus optical waveguide 133-m into the photodetector 615-m of the scanning detector 630-m. In this manner, as the tunable optical add/drop filter 609-m of the scanning detector 630-m scans across all N wavelengths (λ₁ to λ_{N}) of the CW light within the transmit bus optical waveguide 133-m, the photocurrents generated by the photodetectors 607-m-1 to 607-m-N are monitored to generate a mapping of the resonance wavelengths of the wavelength selective modulators 601-m-1 to 601-m-N to the N wavelengths (λ₁ to λ_{N}).

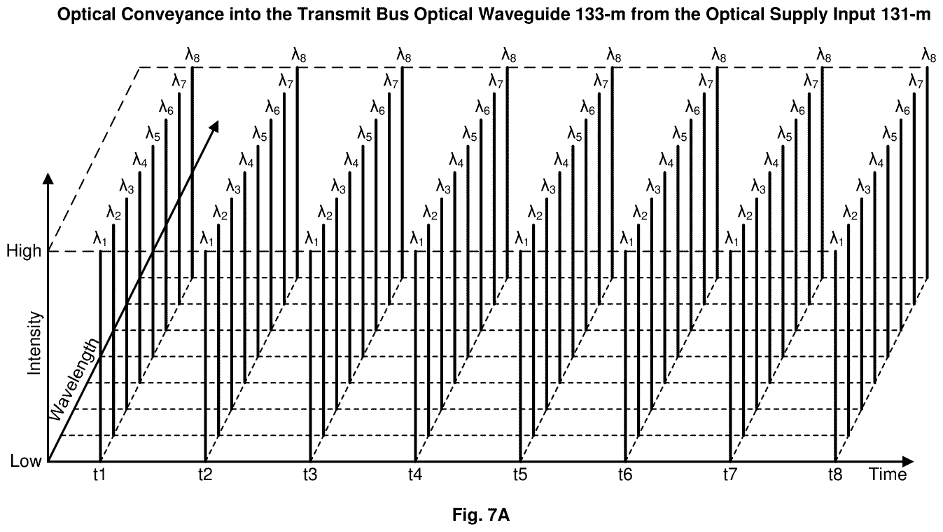

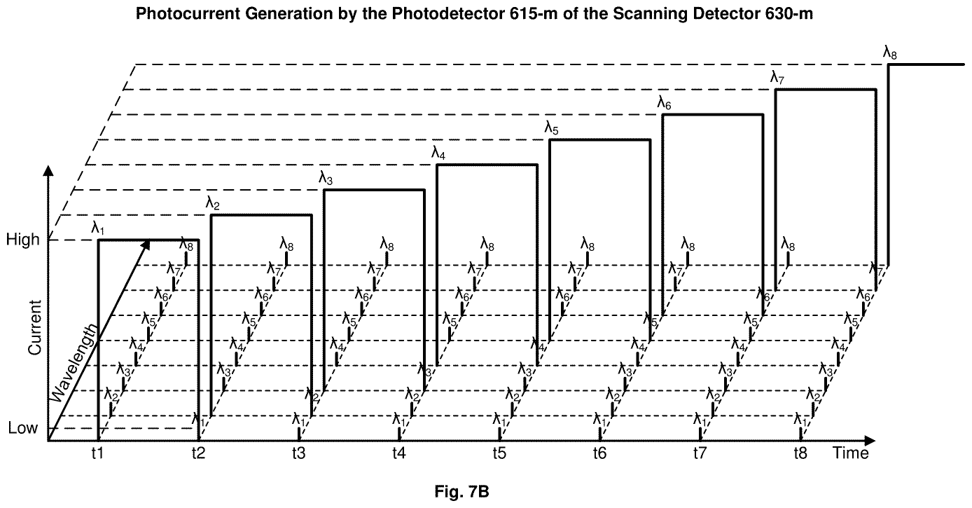

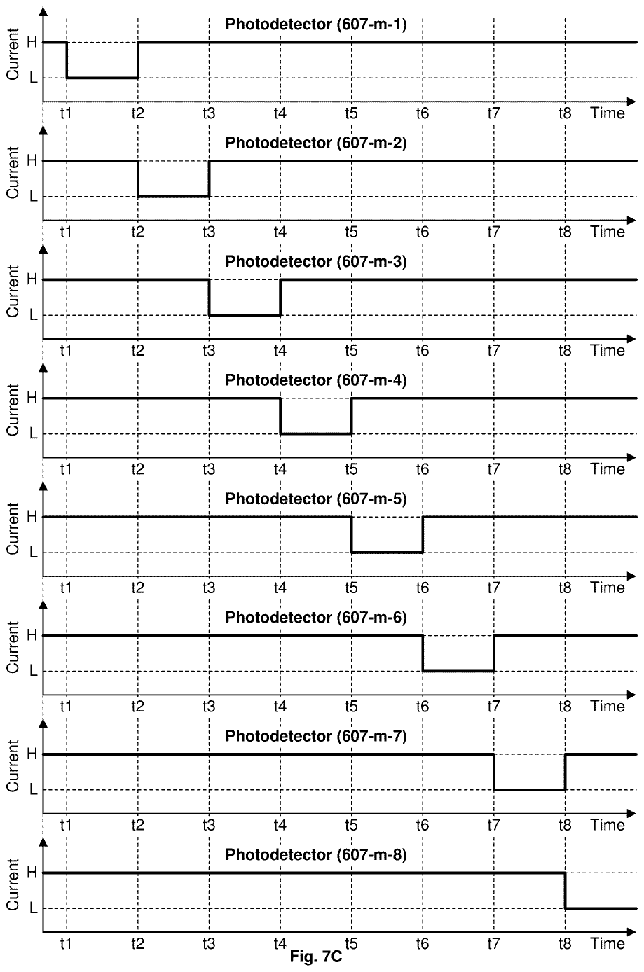

FIG. 7A shows the optical conveyance into the transmit bus optical waveguide 133-m from the optical supply input 131-m, in an example embodiment in which the transmit macro 122-m of FIG. 6A includes eight transmit slices 600-m-1 to 600-m-8, in accordance with some embodiments. FIG. 7A shows how CW light of each wavelength (λ₁ to λ_{N}) is conveyed through the transmit bus optical waveguide 133-m at each of times t1 to t8 during a resonance wavelength mapping for the wavelength selective modulators 601-m-1 to 601-m-N.

FIG. 7B shows the photocurrent generation by the photodetector 615-m of the scanning detector 630-m, in the example embodiment in which the transmit macro 122-m of FIG. 6A includes eight transmit slices 600-m-1 to 600-m-8, in accordance with some embodiments. FIG. 7B shows an example of how the tunable resonance wavelength of the tunable optical add/drop filter 609-m is scanned over wavelengths (λ₁ to λ_{N}) over times t1 to t8 during the resonance wavelength mapping for the wavelength selective modulators 601-m-1 to 601-m-N. Specifically, FIG. 7B shows that at time t1, the resonance wavelength of the tunable optical add/drop filter 609-m is tuned to the wavelength λ₁, such that the CW light having the wavelength λ₁ is diverted from the transmit bus optical waveguide 133-m to the photodetector 615-m. Then, at time t2, the resonance wavelength of the tunable optical add/drop filter 609-m is tuned to the wavelength λ₂, such that the CW light having the wavelength λ₂ is diverted from the transmit bus optical waveguide 133-m to the photodetector 615-m. Then, at time t3, the resonance wavelength of the tunable optical add/drop filter 609-m is tuned to the wavelength λ₃, such that the CW light having the wavelength λ₃ is diverted from the transmit bus optical waveguide 133-m to the photodetector 615-m. Then, at time t4, the resonance wavelength of the tunable optical add/drop filter 609-m is tuned to the wavelength λ₄, such that the CW light having the wavelength λ₄ is diverted from the transmit bus optical waveguide 133-m to the photodetector 615-m. Then, at time t5, the resonance wavelength of the tunable optical add/drop filter 609-m is tuned to the wavelength λ₅, such that the CW light having the wavelength λ₅ is diverted from the transmit bus optical waveguide 133-m to the photodetector 615-m. Then, at time t6, the resonance wavelength of the tunable optical add/drop filter 609-m is tuned to the wavelength λ₆, such that the CW light having the wavelength λ₆ is diverted from the transmit bus optical waveguide 133-m to the photodetector 615-m. Then, at time t7, the resonance wavelength of the tunable optical add/drop filter 609-m is tuned to the wavelength λ₇, such that the CW light having the wavelength λ₇ is diverted from the transmit bus optical waveguide 133-m to the photodetector 615-m. Then, at time t8, the resonance wavelength of the tunable optical add/drop filter 609-m is tuned to the wavelength λ₈, such that the CW light having the wavelength λ₈ is diverted from the transmit bus optical waveguide 133-m to the photodetector 615-m.

It should be understood that the scanning of the resonance wavelength of the tunable optical add/drop filter 609-m in the monotonically increasing manner as depicted in FIG. 7B is provided by way of example. In other embodiments, the resonance wavelength of the tunable optical add/drop filter 609-m is scanned in a different sequence or manner than what is shown in the example of FIG. 7B. Also, in some embodiments, the duration over which a given resonance wavelength of the tunable optical add/drop filter 609-m is held during the scanning of the resonance wavelength of the tunable optical add/drop filter 609-m over the wavelengths (λ₁ to λ_{N}) is adjustable as needed to support the algorithm for mapping out the resonant wavelengths of the wavelength selective modulators 601-m-1 to 601-m-N.

FIG. 7C shows the photocurrents generated by the photodetectors 607-m-1 to 607-m-8 during the resonance wavelength mapping for the wavelength selective modulators 601-m-1 to 601-m-N for the example optical conveyances shown in FIG. 7A and for the example photodetector 615-m photocurrent generation shown in FIG. 7B, in accordance with some embodiments. At time t1, the resonance wavelength of the tunable optical add/drop filter 609-m is λ₁, as shown in FIG. 7B. At time t1, the photodetector 607-m-1 shows the drop in generated photocurrent corresponding to the diversion of optical power of wavelength λ₁ from the transmit bus optical waveguide 133-m to the photodetector 615-m, while the generated photocurrents of the other photodetectors 607-m-2 to 607-m-8 at time t1 do not show any perturbations indicative of optical power diversion from the transmit bus optical waveguide 133-m to the photodetector 615-m. Therefore, monitoring of the photocurrents of the photodetectors 607-m-1 to 607-m-8 at time t1 shows that the wavelength selective modulator 601-m-1 of the transmit slice 600-m-1 is tuned and mapped to the wavelength λ₁.

At time t2, the resonance wavelength of the tunable optical add/drop filter 609-m is λ₂, as shown in FIG. 7B. At time t2, the photodetector 607-m-2 shows the drop in generated photocurrent corresponding to the diversion of optical power of wavelength λ₂ from the transmit bus optical waveguide 133-m to the photodetector 615-m, while the generated photocurrents of the other photodetectors 607-m-1 and 607-m-3 to 607-m-8 at time t2 do not show any perturbations indicative of optical power diversion from the transmit bus optical waveguide 133-m to the photodetector 615-m. Therefore, monitoring of the photocurrents of the photodetectors 607-m-1 to 607-m-8 at time t2 shows that the wavelength selective modulator 601-m-2 of the transmit slice 600-m-2 is tuned and mapped to the wavelength λ₂.

At time t3, the resonance wavelength of the tunable optical add/drop filter 609-m is λ₃, as shown in FIG. 7B. At time t3, the photodetector 607-m-3 shows the drop in generated photocurrent corresponding to the diversion of optical power of wavelength λ₃ from the transmit bus optical waveguide 133-m to the photodetector 615-m, while the generated photocurrents of the other photodetectors 607-m-1 to 607-m-2 and 607-m-4 to 607-m-8 at time t3 do not show any perturbations indicative of optical power diversion from the transmit bus optical waveguide 133-m to the photodetector 615-m. Therefore, monitoring of the photocurrents of the photodetectors 607-m-1 to 607-m-8 at time t3 shows that the wavelength selective modulator 601-m-3 of the transmit slice 600-m-3 is tuned and mapped to the wavelength λ₃.

At time t4, the resonance wavelength of the tunable optical add/drop filter 609-m is λ₄, as shown in FIG. 7B. At time t4, the photodetector 607-m-4 shows the drop in generated photocurrent corresponding to the diversion of optical power of wavelength λ₄ from the transmit bus optical waveguide 133-m to the photodetector 615-m, while the generated photocurrents of the other photodetectors 607-m-1 to 607-m-3 and 607-m-5 to 607-m-8 at time t4 do not show any perturbations indicative of optical power diversion from the transmit bus optical waveguide 133-m to the photodetector 615-m. Therefore, monitoring of the photocurrents of the photodetectors 607-m-1 to 607-m-8 at time t4 shows that the wavelength selective modulator 601-m-4 of the transmit slice 600-m-4 is tuned and mapped to the wavelength λ₄.

At time t5, the resonance wavelength of the tunable optical add/drop filter 609-m is λ₅, as shown in FIG. 7B. At time t5, the photodetector 607-m-5 shows the drop in generated photocurrent corresponding to the diversion of optical power of wavelength λ₅ from the transmit bus optical waveguide 133-m to the photodetector 615-m, while the generated photocurrents of the other photodetectors 607-m-1 to 607-m-4 and 607-m-6 to 607-m-8 at time t5 do not show any perturbations indicative of optical power diversion from the transmit bus optical waveguide 133-m to the photodetector 615-m. Therefore, monitoring of the photocurrents of the photodetectors 607-m-1 to 607-m-8 at time t5 shows that the wavelength selective modulator 601-m-5 of the transmit slice 600-m-5 is tuned and mapped to the wavelength λ₅.

At time t6, the resonance wavelength of the tunable optical add/drop filter 609-m is λ₆, as shown in FIG. 7B. At time t6, the photodetector 607-m-6 shows the drop in generated photocurrent corresponding to the diversion of optical power of wavelength λ₆ from the transmit bus optical waveguide 133-m to the photodetector 615-m, while the generated photocurrents of the other photodetectors 607-m-1 to 607-m-5 and 607-m-7 to 607-m-8 at time t6 do not show any perturbations indicative of optical power diversion from the transmit bus optical waveguide 133-m to the photodetector 615-m. Therefore, monitoring of the photocurrents of the photodetectors 607-m-1 to 607-m-8 at time t6 shows that the wavelength selective modulator 601-m-6 of the transmit slice 600-m-6 is tuned and mapped to the wavelength λ₆.

At time t7, the resonance wavelength of the tunable optical add/drop filter 609-m is λ₇, as shown in FIG. 7B. At time t7, the photodetector 607-m-7 shows the drop in generated photocurrent corresponding to the diversion of optical power of wavelength λ₇ from the transmit bus optical waveguide 133-m to the photodetector 615-m, while the generated photocurrents of the other photodetectors 607-m-1 to 607-m-6 and 607-m-8 at time t7 do not show any perturbations indicative of optical power diversion from the transmit bus optical waveguide 133-m to the photodetector 615-m. Therefore, monitoring of the photocurrents of the photodetectors 607-m-1 to 607-m-8 at time t7 shows that the wavelength selective modulator 601-m-7 of the transmit slice 600-m-7 is tuned and mapped to the wavelength λ₇.

At time t8, the resonance wavelength of the tunable optical add/drop filter 609-m is λ₈, as shown in FIG. 7B. At time t8, the photodetector 607-m-8 shows the drop in generated photocurrent corresponding to the diversion of optical power of wavelength λ₈ from the transmit bus optical waveguide 133-m to the photodetector 615-m, while the generated photocurrents of the other photodetectors 607-m-1 to 607-m-7 at time t8 do not show any perturbations indicative of optical power diversion from the transmit bus optical waveguide 133-m to the photodetector 615-m. Therefore, monitoring of the photocurrents of the photodetectors 607-m-1 to 607-m-8 at time t8 shows that the wavelength selective modulator 601-m-8 of the transmit slice 600-m-8 is tuned and mapped to the wavelength λ₈.

In some embodiments, such as shown in FIGS. 7A, 7B, and 7C, the resonance wavelengths of the wavelength selective modulators 601-m-1 to 601-m-N of the transmit macro 122-m are tuned in a monotonically increasing manner, such that the resonance wavelength of the wavelength selective modulator 601-m-1 of the first transmit slice 600-m-1 is tuned to the lowest wavelength of λ₁, and the resonance wavelength of the wavelength selective modulator 601-m-N of the N^{th} transmit slice 600-m-N is tuned to the highest wavelength of λ_{N}, with the intervening resonance wavelengths of the wavelength selective modulators 601-m-2 to 601-m-(N-1) of the transmit slices 600-m-2 to 600-m-(N-1) tuned to have monotonically increasing wavelengths of λ₂ to λ_{(N-1)} . However, it should be understood that in some embodiments the resonance wavelengths of the wavelength selective modulators 601-m-1 to 601-m-N of the transmit macro 122-m are tuned in an arbitrary sequence across the transmit slices 600-m-1 to 600-m-N.

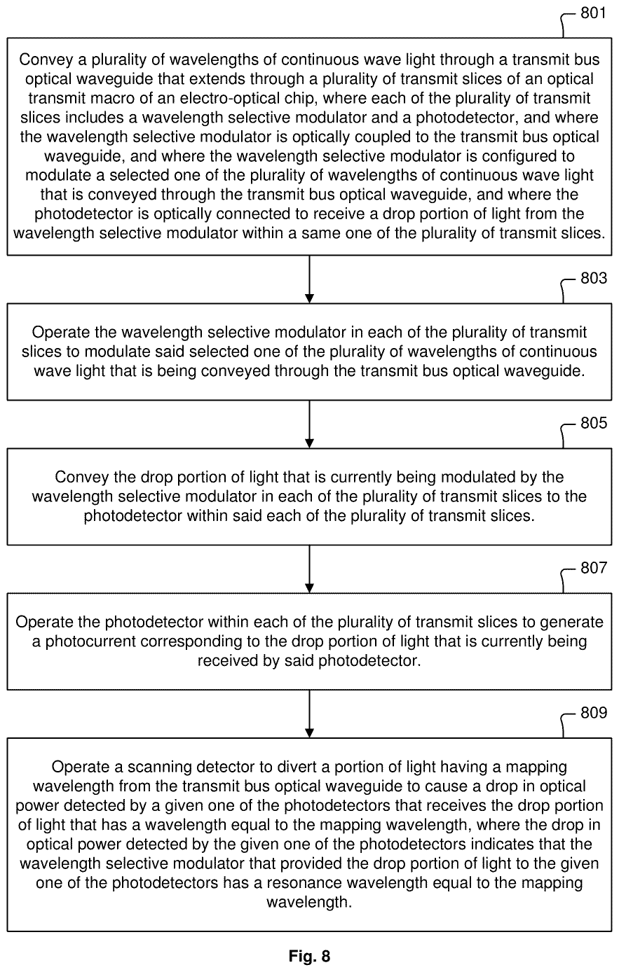

FIG. 8 shows a flowchart of a method for mapping resonance wavelengths of wavelength selective modulators 601-m-1 to 601-m-N across the optical transmit macro 122-m of the electro-optical chip 102, in accordance with some embodiments. The method includes an operation for 801 for conveying a plurality of wavelengths (λ₁ to λ_{N}) of CW light through the transmit bus optical waveguide 133-m that extends through the plurality of transmit slices 600-m-1 to 600-m-N of the optical transmit macro 122-m of the electro-optical chip 102. Each of the plurality of transmit slices 600-m-1 to 600-m-N includes the wavelength selective modulator 601-m-1 to 601-m-N and the photodetector 607-m-1 to 607-m-N. The wavelength selective modulator 601-m-1 to 601-m-N is optically coupled to the transmit bus optical waveguide 133-m. The wavelength selective modulator 601-m-1 to 601-m-N is configured to modulate a selected one of the plurality of wavelengths (λ₁ to λ_{N}) of CW light that is conveyed through the transmit bus optical waveguide 133-m. The photodetector 607-m-1 to 607-m-N is optically connected to receive a drop portion of light from the wavelength selective modulator 601-m-1 to 601-m-N within a same one of the plurality of transmit slices 600-m-1 to 600-m-N. The method also includes an operation 803 for operating the wavelength selective modulator 601-m-1 to 601-m-N in each of the plurality of transmit slices 600-m-1 to 600-m-N to modulate said selected one of the plurality of wavelengths (λ₁ to λ_{N}) of CW light that is being conveyed through the transmit bus optical waveguide 133-m. The method also includes an operation 805 for conveying the drop portion of light that is currently being modulated by the wavelength selective modulator 601-m-1 to 601-m-N in each of the plurality of transmit slices 600-m-1 to 600-m-N to the photodetector 607-m-1 to 607-m-N within said each of the plurality of transmit slices 600-m-1 to 600-m-N. The method also includes an operation 807 for operating the photodetector 607-m-1 to 607-m-N within each of the plurality of transmit slices 600-m-1 to 600-m-N to generate a photocurrent corresponding to the drop portion of light that is currently being received by said photodetector 607-m-1 to 607-m-N. The method also includes an operation 809 for operating the scanning detector 630-m to divert a portion of light having a mapping wavelength from the transmit bus optical waveguide 133-m to cause a drop in optical power detected by a given one of the photodetectors 607-m-1 to 607-m-N that receives the drop portion of light that has a wavelength equal to the mapping wavelength. The drop in optical power detected by the given one of the photodetectors 607-m-1 to 607-m-N indicates that the corresponding wavelength selective modulator 601-m-1 to 601-m-N that provided the drop portion of light to the given one of the photodetectors 607-m-1 to 607-m-N has a resonance wavelength equal to the mapping wavelength.

In some embodiments, the method includes operating the scanning detector 630-m to divert different portions of light having different mapping wavelengths from the transmit bus optical waveguide 133-m until the resonance wavelength of each wavelength selective modulator 601-m-1 to 601-m-N within the plurality of transmit slices 600-m-1 to 600-m-N is matched to one of the different mapping wavelengths. In some embodiments, operating the scanning detector 630-m in the operation 809 includes operating a tunable optical add/drop filter 609-m to divert the portion of light having the mapping wavelength from the transmit bus optical waveguide 133-m. In some embodiments, the method includes conveying the portion of light having the mapping wavelength from the transmit bus optical waveguide 133-m into a photodetector 615-m of the scanning detector 630-m to facilitate tuning of a resonance wavelength of the tunable optical add/drop filter 609-m to match the mapping wavelength.

The foregoing description of the embodiments has been provided for purposes of illustration and description, and is not intended to be exhaustive or limiting. Individual elements or features of a particular embodiment are generally not limited to that particular embodiment, but, where applicable, are interchangeable and can be used in a selected embodiment, even if not specifically shown or described. In this manner, one or more features from one or more embodiments disclosed herein can be combined with one or more features from one or more other embodiments disclosed herein to form another embodiment that is not explicitly disclosed herein, but rather that is implicitly disclosed herein. This other embodiment may also be varied in many ways. Such embodiment variations are not to be regarded as a departure from the disclosure herein, and all such embodiment variations and modifications are intended to be included within the scope of the disclosure provided herein.

Although some method operations may be described in a specific order herein, it should be understood that other housekeeping operations may be performed in between method operations, and/or method operations may be adjusted so that they occur at slightly different times or simultaneously or may be distributed in a system which allows the occurrence of the processing operations at various intervals associated with the processing, as long as the processing of the method operations are performed in a manner that provides for successful implementation of the method.

Although the foregoing embodiments have been described in some detail for purposes of clarity of understanding, it will be apparent that certain changes and modifications can be practiced within the scope of the appended claims. Accordingly, the embodiments disclosed herein are to be considered as illustrative and not restrictive, and are therefore not to be limited to just the details given herein, but may be modified within the scope and equivalents of the appended claims.

What is claimed is:

1. An optical transmit macro of an electro-optical chip, comprising:
a transmit bus optical waveguide optically connected to an optical supply input;
a plurality of transmit slices, the transmit bus optical waveguide extending through the plurality of transmit slices, each of the plurality of transmit slices including a wavelength selective modulator optically coupled to the transmit bus optical waveguide, the wavelength selective modulator configured to modulate a selected wavelength of light that is being conveyed through the transmit bus optical waveguide;
a mapping bus optical waveguide extending through the plurality of transmit slices;
a scanning detector disposed along the transmit bus optical waveguide at a location between the optical supply input and the plurality of transmit slices, the scanning detector configured to provide controlled diversion of a portion of light having a particular wavelength from the transmit bus optical waveguide to the mapping bus optical waveguide, wherein the portion of light diverted by the scanning detector is a mapping light, and wherein the particular wavelength of the mapping light is a mapping wavelength; and
a phase shifter optically coupled to the mapping bus optical waveguide at a location between the scanning detector and the plurality of transmit slices, the phase shifter configured to impart a phase modulation pattern onto the mapping light conveyed through the mapping bus optical waveguide,
wherein each of the plurality of transmit slices is configured to combine a portion of the mapping light from within the mapping bus optical waveguide with a drop portion of light currently coupled into the wavelength selective modulator of said each of the plurality of transmit slices to determine whether or not the phase modulation pattern of the mapping light is imparted onto the drop portion of light so as to indicate a match between the mapping wavelength and a resonance wavelength of the wavelength selective modulator of said each of the plurality of transmit slices.

2. The optical transmit macro of the electro-optical chip as recited in claim 1, wherein the scanning detector includes an optical tap coupler, a tunable optical add/drop filter, an optical coupler, and a photodetector, wherein the optical tap coupler is optically coupled to the transmit bus optical waveguide, wherein the optical tap coupler is configured to direct a portion of optical power within the transmit bus optical waveguide to the tunable optical add/drop filter, wherein the tunable optical add/drop filter is configured to convey the mapping light having the mapping wavelength to the optical coupler, wherein the optical coupler is configured to convey a first portion of the mapping light into the photodetector and a second portion of the mapping light into the mapping bus optical waveguide.

3. The optical transmit macro of the electro-optical chip as recited in claim 2, wherein the photodetector is configured to assist with resonance wavelength tuning of the tunable optical add/drop filter to convey the mapping light having the mapping wavelength into the optical coupler.

4. The optical transmit macro of the electro-optical chip as recited in claim 2, wherein the tunable optical add/drop filter is implemented as a microring resonator.

5. The optical transmit macro of the electro-optical chip as recited in claim 4, wherein the tunable optical add/drop filter implements thermo-optic tuning in which electrical current is driven through a conductive structure near the microring resonator to heat the microring resonator and correspondingly shift a resonance wavelength of the tunable optical add/drop filter.

6. The optical transmit macro of the electro-optical chip as recited in claim 1, further comprising:
a variable optical attenuator optically connected to the mapping bus optical waveguide at a location between the scanning detector and the plurality of transmit slices, the variable optical attenuator configured to control an amount of optical power that is conveyed through the mapping bus optical waveguide to the plurality of transmit slices.

7. The optical transmit macro of the electro-optical chip as recited in claim 1, wherein each of the plurality of transmit slices includes an optical tap coupler optically coupled to the mapping bus optical waveguide, wherein each of the plurality of transmit slices includes a mapping coupler having a first optical input optically connected to an optical output port of the optical tap coupler, wherein the mapping coupler has a second optical input optically connected to a drop port of the wavelength selective modulator of said each of the plurality of transmit slices, wherein the mapping coupler is configured to combine the portion of the mapping light from within the mapping bus optical waveguide with the drop portion of light received from the drop port, wherein the mapping coupler has an optical output port optically connected to a photodetector, wherein a photocurrent generated by the photodetector indicates when the phase modulation pattern of the mapping light is imparted onto the drop portion of light received from the drop port.

8. The optical transmit macro of the electro-optical chip as recited in claim 7, wherein each of the plurality of transmit slices includes a passive optical attenuator optically connected between the drop port of the wavelength selective modulator and the second optical input of the mapping coupler.

9. The optical transmit macro of the electro-optical chip as recited in claim 7, wherein each of the plurality of transmit slices includes a supplemental photodetector optically connected to a second optical output port of the mapping coupler.

10. The optical transmit macro of the electro-optical chip as recited in claim 9, wherein each of the plurality of transmit slices includes a passive optical attenuator optically connected between the drop port of the wavelength selective modulator and the second optical input of the mapping coupler.

11. The optical transmit macro of the electro-optical chip as recited in claim 1, wherein the wavelength selective modulator within each of the plurality of transmit slices is implemented as a microring modulator.

12. The optical transmit macro of the electro-optical chip as recited in claim 1, wherein the transmit bus optical waveguide extends from the plurality of transmit slices to an optical signal output of the optical transmit macro of the electro-optical chip.

13. The optical transmit macro of the electro-optical chip as recited in claim 1, wherein each of the plurality of transmit slices includes a ring locking photodetector optically connected to a drop port of the wavelength selective modulator of said each of the plurality of transmit slices through a drop optical waveguide within said each of the plurality of transmit slices, wherein each of the plurality of transmit slices includes a first optical tap coupler optically coupled to the drop optical waveguide, wherein each of the plurality of transmit slices includes a mapping coupler having a first optical input port optically connected to an optical output port of the first optical tap coupler, wherein each of the plurality of transmit slices includes a second optical tap coupler optically coupled to the mapping bus optical waveguide, wherein the mapping coupler has a second optical input optically connected to an optical output port of the second optical tap coupler, wherein the mapping coupler is configured to combine the portion of the mapping light from within the mapping bus optical waveguide with the drop portion of light received from the drop port, wherein the mapping coupler has an optical output port optically connected to a mapping photodetector, wherein a photocurrent generated by the mapping photodetector indicates when the phase modulation pattern of the mapping light is imparted onto the drop portion of light received from the drop port.

14. The optical transmit macro of the electro-optical chip as recited in claim 13, wherein the ring locking photodetector and the mapping photodetector are implemented as separate photodetectors within each of the plurality of transmit slices.

15. A method for mapping resonance wavelengths of wavelength selective modulators across an optical transmit macro of an electro-optical chip, comprising:
conveying a plurality of wavelengths of continuous wave light through a transmit bus optical waveguide that extends through a plurality of transmit slices of an optical transmit macro of an electro-optical chip, wherein each of the plurality of transmit slices includes a wavelength selective modulator optically coupled to the transmit bus optical waveguide, the wavelength selective modulator configured to modulate a selected one of the plurality of wavelengths of continuous wave light that is being conveyed through the transmit bus optical waveguide;
operating the wavelength selective modulator in each of the plurality of transmit slices to modulate said selected one of the plurality of wavelengths of continuous wave light that is being conveyed through the transmit bus optical waveguide;
operating a scanning detector to divert a portion of light having a particular wavelength from the transmit bus optical waveguide to a mapping bus optical waveguide, wherein the portion of light diverted by the scanning detector is a mapping light, and wherein the particular wavelength of the mapping light is a mapping wavelength, wherein the mapping bus optical waveguide extends from the scanning detector through the plurality of transmit slices;
operating a phase shifter to impart a phase modulation pattern onto the mapping light conveyed through the mapping bus optical waveguide at a location upstream from the plurality of transmit slices relative to a light propagation direction through the mapping bus optical waveguide; and
combining a portion of the mapping light from the mapping bus optical waveguide with a drop portion of light currently optically coupled into the wavelength selective modulator in each of the plurality of transmit slices to determine whether or not the phase modulation pattern of the mapping light is imparted onto the drop portion of light, wherein imparting of the phase modulation pattern of the mapping light onto the drop portion of light is indicative of a match between the mapping wavelength of the mapping light and a resonance wavelength of the wavelength selective modulator from which the drop portion of light is obtained.

16. The method as recited in claim 15, further comprising:
operating the scanning detector to divert different portions of light having different mapping wavelengths from the transmit bus optical waveguide until the resonance wavelength of each wavelength selective modulator within the plurality of transmit slices is matched to one of the different mapping wavelengths.

17. The method as recited in claim 15, wherein operating the scanning detector includes operating a tunable optical add/drop filter to divert the mapping light having the mapping wavelength from the transmit bus optical waveguide to the mapping bus optical waveguide.

18. The method as recited in claim 15, wherein combining the portion of the mapping light from the mapping bus optical waveguide with the drop portion of light currently optically coupled into the wavelength selective modulator is done by operating a mapping coupler that receives the mapping light and the drop portion of light as inputs and that conveys an optical output signal to a photodetector, wherein the method further includes monitoring a photocurrent generated by the photodetector to determine when an amplitude variation of the optical output signal indicates that the mapping light is imparted onto the drop portion of light due to the mapping wavelength matching the resonance wavelength of the wavelength selective modulator from which the drop portion of light is obtained.

19. The method as recited in claim 18, wherein said photodetector is a mapping photodetector, wherein the method further includes conveying some of the drop portion of light into a ring locking photodetector to facilitate locking of the resonance wavelength of the wavelength selective modulator, wherein the mapping photodetector and the ring locking photodetector are operated independently of each other.

20. The method as recited in claim 15, further comprising:
operating a variable optical attenuator optically coupled to the mapping bus optical waveguide to control an optical power within the mapping bus optical waveguide upstream of the plurality of transmit slices relative to a light propagation direction through the mapping bus optical waveguide.

21. An optical transmit macro of an electro-optical chip, comprising:
a transmit bus optical waveguide optically connected to an optical supply input;
a plurality of transmit slices, the transmit bus optical waveguide extending through the plurality of transmit slices, each of the plurality of transmit slices including a wavelength selective modulator optically coupled to the transmit bus optical waveguide, the wavelength selective modulator configured to modulate a selected wavelength of light that is being conveyed through the transmit bus optical waveguide, each of the plurality of transmit slices including a photodetector optically connected to receive a drop portion of light currently coupled into the wavelength selective modulator of said each of the plurality of transmit slices; and
a scanning detector disposed along the transmit bus optical waveguide at a location between the optical supply input and the plurality of transmit slices, the scanning detector configured to provide controlled diversion of a portion of light having a mapping wavelength from the transmit bus optical waveguide, which correspondingly causes a drop in optical power detected by one of the photodetectors within a given one of the plurality of transmit slices that receives the drop portion of light that has a wavelength equal to the mapping wavelength, which indicates that the wavelength selective modulator of the given one of the plurality of transmit slices has a resonance wavelength equal to the mapping wavelength.

22. The optical transmit macro of the electro-optical chip as recited in claim 21, wherein the scanning detector includes a tunable optical add/drop filter and a photodetector, wherein the tunable optical add/drop filter is optically coupled to the transmit bus optical waveguide, wherein the tunable optical add/drop filter is configured to convey the portion of light having the mapping wavelength from the transmit bus optical waveguide through an optical waveguide to the photodetector.

23. The optical transmit macro of the electro-optical chip as recited in claim 22, wherein the photodetector is configured to assist with resonance wavelength tuning of the tunable optical add/drop filter to match the mapping wavelength.

24. The optical transmit macro of the electro-optical chip as recited in claim 22, wherein the tunable optical add/drop filter is implemented as a microring resonator.

25. The optical transmit macro of the electro-optical chip as recited in claim 24, wherein the tunable optical add/drop filter implements thermo-optic tuning in which electrical current is driven through a conductive structure near the microring resonator to heat the microring resonator and correspondingly shift a resonance wavelength of the tunable optical add/drop filter.

26. The optical transmit macro of the electro-optical chip as recited in claim 21, wherein each of the plurality of transmit slices includes an optical waveguide configured to optically connect a drop port of the wavelength selective modulator to the photodetector of said each of the plurality of transmit slices.

27. The optical transmit macro of the electro-optical chip as recited in claim 21, wherein the wavelength selective modulator within each of the plurality of transmit slices is implemented as a microring modulator.

28. The optical transmit macro of the electro-optical chip as recited in claim 21, wherein the transmit bus optical waveguide extends from the plurality of transmit slices to an optical signal output of the optical transmit macro of the electro-optical chip.

29. A method for mapping resonance wavelengths of wavelength selective modulators across an optical transmit macro of an electro-optical chip, comprising:
conveying a plurality of wavelengths of continuous wave light through a transmit bus optical waveguide that extends through a plurality of transmit slices of an optical transmit macro of an electro-optical chip, wherein each of the plurality of transmit slices includes a wavelength selective modulator and a photodetector, the wavelength selective modulator optically coupled to the transmit bus optical waveguide, the wavelength selective modulator configured to modulate a selected one of the plurality of wavelengths of continuous wave light that is conveyed through the transmit bus optical waveguide, the photodetector optically connected to receive a drop portion of light from the wavelength selective modulator within a same one of the plurality of transmit slices;
operating the wavelength selective modulator in each of the plurality of transmit slices to modulate said selected one of the plurality of wavelengths of continuous wave light that is being conveyed through the transmit bus optical waveguide;
conveying the drop portion of light that is currently being modulated by the wavelength selective modulator in each of the plurality of transmit slices to the photodetector within said each of the plurality of transmit slices;
operating the photodetector within each of the plurality of transmit slices to generate a photocurrent corresponding to the drop portion of light that is currently being received by said photodetector; and
operating a scanning detector to divert a portion of light having a mapping wavelength from the transmit bus optical waveguide to cause a drop in optical power detected by a given one of the photodetectors that receives the drop portion of light that has a wavelength equal to the mapping wavelength, wherein the drop in optical power detected by the given one of the photodetectors indicates that the wavelength selective modulator that provided the drop portion of light to the given one of the photodetectors has a resonance wavelength equal to the mapping wavelength.

30. The method as recited in claim 29, further comprising:
operating the scanning detector to divert different portions of light having different mapping wavelengths from the transmit bus optical waveguide until the resonance wavelength of each wavelength selective modulator within the plurality of transmit slices is matched to one of the different mapping wavelengths.

31. The method as recited in claim 29, wherein operating the scanning detector includes operating a tunable optical add/drop filter to divert the portion of light having the mapping wavelength from the transmit bus optical waveguide.

32. The method as recited in claim 31, further comprising:
conveying the portion of light having the mapping wavelength from the transmit bus optical waveguide into a photodetector of the scanning detector to facilitate tuning of a resonance wavelength of the tunable optical add/drop filter to match the mapping wavelength.
